(19) United States
(12) Patent Application Publication
(10) Pub. No.: US 2016/0162934 A1
(43) Pub. Date: Jun. 9, 2016

(54) ADVERTISEMENT DISTRIBUTION MANAGEMENT DEVICE, ADVERTISEMENT DISTRIBUTION MANAGEMENT METHOD, AND NON-TRANSITORY COMPUTER READABLE STORAGE MEDIUM

(71) Applicant: YAHOO JAPAN CORPORATION, Tokyo (JP)

(72) Inventors: Shinichiro SEGA, Tokyo (JP); Yuichiro NISHIMAKI, Tokyo (JP)

(73) Assignee: YAHOO JAPAN CORPORATION, Tokyo (JP)

(21) Appl. No.: 14/958,523

(22) Filed: Dec. 3, 2015

(30) Foreign Application Priority Data
Dec. 9, 2014 (JP) 2014-249205

(51) Int. Cl. G06Q 30/02; H04L 29/08

(52) U.S. Cl. CPC G06Q 30/0247; H04L 67/20; H04L 67/16

(57) ABSTRACT

An advertisement distribution management device according to the present resent invention includes an acquiring unit, a determination unit, and a sending unit. The acquiring unit acquires, for each number of advertisement requests sent to an advertisement distribution device per unit time, a profit expected value of advertising content that is distributed by the advertisement distribution device in accordance with the advertisement requests. The determination unit determines, on the basis of the profit expected value acquired by the acquiring unit, the number of allocations of the advertisement requests to be allocated to the advertisement distribution device. The sending unit sends, on the basis of the number of allocations determined by the determination unit, a new advertisement request to the advertisement distribution device. Consequently, the advertisement distribution management device can improve the profit obtained from the distribution of the advertising content.

### CROSS-REFERENCE TO RELATED APPLICATION(S)

The present application claims priority to and incorporates by reference the entire contents of Japanese Patent Application No. 2014-249205 filed in Japan on Dec. 9, 2014.

### BACKGROUND OF THE INVENTION

1. Field of the Invention

The present invention relates to an advertisement distribution management device, an advertisement distribution management method, and a non-transitory computer readable storage medium.

2. Description of the Related Art

In recent years, with the rapid spread of the Internet, advertisement distribution through the Internet has been actively performed. For example, advertisement distribution is performed in which advertising content of, for example, a company, a product, or the like, is displayed in an advertising space that is set on a web page and, when the advertising content is clicked, the advertising content is transferred to a web page of an advertiser.

Here, there is a proposed technology in which profits are obtained by providing advertising spaces with a plurality of ad networks and receiving, from advertisement distribution vendors that manage the ad networks, a part of sales on the basis of the number of impressions or the number of clicks of the advertising content displayed on the provided advertising spaces (Japanese Laid-open Patent Publication No. 2010-237851).

At this time, in order to improve the obtained profit, it is desired that an ad network that is the providing destination of the advertising space is appropriately selected from among the plurality of ad networks. Thus, with this technology, profits are improved by predicting an effective cost per mille (eCPM) of each of the ad networks and selecting an ad network on the basis of the predicted eCPM.

However, the conventional technology described above does not always enable to improve the profits obtained by allowing advertisement distribution vendors to distribute advertising content. Specifically, the conventional technology described above merely selects an advertisement distribution vendor on the basis of eCPM predicted for each ad network and thus does not always enable to improve the profits obtained by allowing the selected advertisement distribution vendor to distribute the advertising content.

### SUMMARY OF THE INVENTION

It is an object of the present invention to at least partially solve the problems in the conventional technology.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1A is a schematic diagram illustrating an example of an advertisement distribution process according to a first embodiment;

FIG. 1B is a schematic diagram illustrating an example of the average eCPM of each of the number of advertisement requests per unit time in each of advertisement distribution devices;

FIG. 2 is a schematic diagram illustrating a configuration example of an advertisement distribution system according to the first embodiment;

FIG. 3 is a schematic diagram illustrating a configuration example of an advertisement distribution management device according to the first embodiment;

FIG. 4 is a schematic diagram illustrating an example of a statistical information storing unit according to the first embodiment;

FIG. 5A is a flowchart illustrating the flow of a number of allocations determination process performed by the advertisement distribution management device according to the first embodiment;

FIG. 5B is a flowchart illustrating the flow of a distribution process performed by the advertisement distribution management device according to the first embodiment;

FIG. 6A is a schematic diagram illustrating an example of an advertisement distribution process according to a second embodiment;

FIG. 6B is a schematic diagram illustrating an example of a price terms table;

FIG. 6C is a schematic diagram illustrating an example of the average eCPM of each of the number of advertisement requests per unit time in each Zone;

FIG. 7 is a schematic diagram illustrating a configuration example of an advertisement distribution management device according to the second embodiment;

FIG. 8 is a schematic diagram illustrating an example of the relationship between profit expected values and price ranks;

FIG. 9 is a schematic diagram illustrating an example of a statistical information storing unit according to the second embodiment;

FIG. 10A is a flowchart illustrating the flow of a number of allocations determination process performed by the advertisement distribution management device according to the second embodiment;

FIG. 10B is a flowchart illustrating the flow of a distribution process performed by the advertisement distribution management device according to the second embodiment;

FIG. 11A is a schematic diagram illustrating the relationship between the number of advertisement requests and the number of allocations based on a distribution track record in each Zone;

FIG. 11B is a schematic diagram illustrating advertisement request transmission destinations; and

FIG. 12 is a block diagram illustrating the hardware configuration indicating an example of a computer that implements the function performed by the advertisement distribution management device.

### DETAILED-DESCRIPTION OF THE PREFERRED EMBODIMENTS

A mode (hereinafter, referred to as an “embodiment”) for implementing an advertisement distribution management device, an advertisement distribution management method, and an advertisement distribution management program according to the present invention will be described in detail below with reference to the drawings. Note that the advertisement distribution management device, the advertisement distribution management method, and the advertisement distribution management program according to the present invention are not limited to the embodiment. Furthermore, note that in the embodiments described below, the same components are denoted by the same reference signs and an overlapping description is omitted.

### First Embodiment

### 1. Advertisement Distribution Process

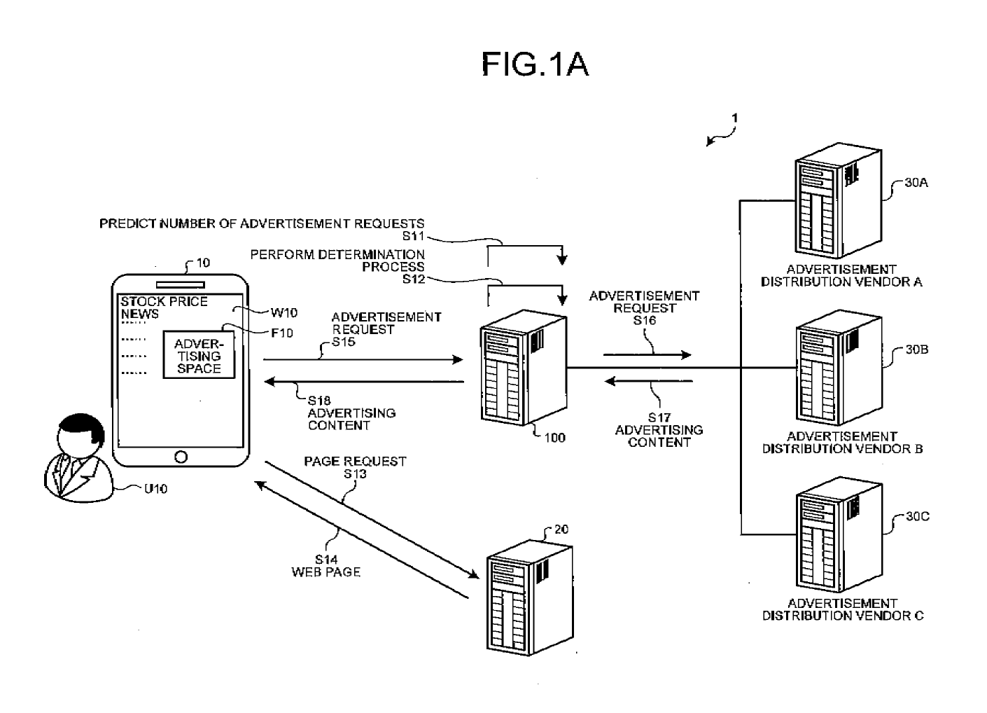

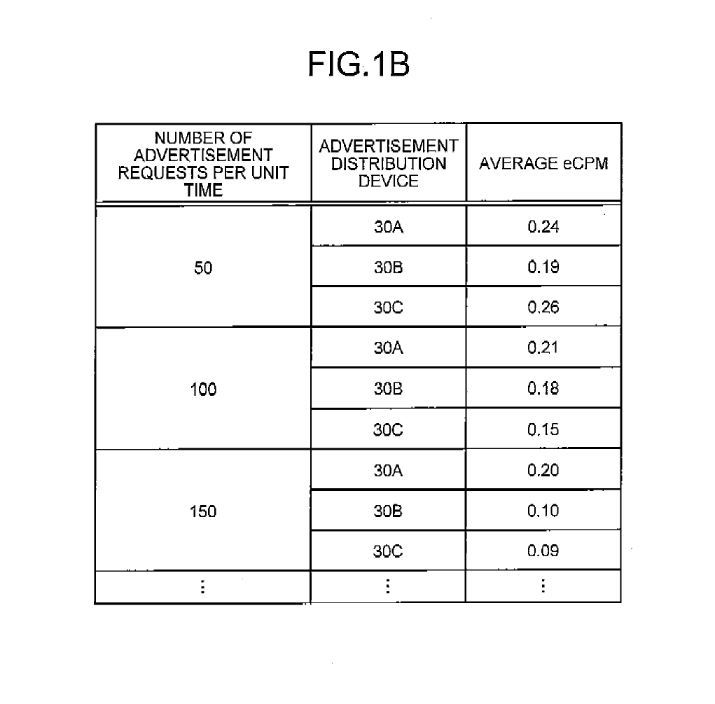

First, an example of an advertisement distribution process according to a first embodiment will be described. FIG. 1A is a schematic diagram illustrating an example of an advertisement distribution process according to a first embodiment. In the first embodiment, the advertisement distribution process is performed by an advertisement distribution system. In a description below, an example in which advertising content is displayed on a web page is used as an example; however, the advertising content may also be displayed on an advertisement display medium other than the web page. For example, the advertising content may also be displayed on an advertisement display medium, such as a game application, a book reading application, a music distribution application, a video distribution application, or the like.

As illustrated in FIG. 1A, an advertisement distribution system 1 according to the first embodiment includes a web server 20, advertisement distribution devices 30A to 30C, and an advertisement distribution management device 100. These devices are connected via a communication network such that they can communicate with each other.

In FIG. 1A, it is assumed that the advertisement distribution device 30A, the advertisement distribution device 30B, and the advertisement distribution device 30C are managed and operated by an advertisement distribution vendor A, an advertisement distribution vendor B, and an advertisement distribution vendor C, respectively. Furthermore, it is assumed that the web server 20 and the advertisement distribution management device 100 are managed and operated by an administrator X. The web server 20 stores therein a plurality of web pages and sends, to a terminal device 10, a web page in accordance with a page request received from the terminal device 10. Furthermore, although not illustrated, it is assumed that a plurality of the terminal devices 10 is included in the advertisement distribution system 1.

By sending an advertisement request that is a request for advertising content displayed on a predetermined advertising space on a web page to each of the advertisement distribution devices, the advertisement distribution management device 100 allows the advertisement distribution devices at the transmission destination to distribute the advertising content. Then, an administrator of the advertisement distribution device distributes the advertising content, whereby the administrator receives advertisement expenses from an advertiser on the basis of, for example, the number of impressions or the number of clicks. Then, the administrator of the advertisement distribution device pays, to the administrator X of the advertisement distribution management device 100, a part of the advertisement expense received from the advertiser. Namely, the administrator X of the advertisement distribution management device 100 allows each of the advertisement distribution devices to distribute the advertising content by using the advertisement distribution management device 100, whereby the administrator X obtains a part of sales in each of the advertisement distribution devices as a profit.

At this time, in order to improve the profit obtained by the administrator X of the advertisement distribution management device 100, the advertisement distribution management device 100 determines the number of advertisement requests to be sent to each of the advertisement distribution devices. Specifically, the advertisement distribution management device 100 acquires, for each of the number of the advertisement requests that have been sent to the advertisement distribution device per unit time, statistical data of profit expected values of the advertising content that is delivered by the advertisement distribution device in accordance with the advertisement requests. Then, the advertisement distribution management device 100 determines, on the basis of the acquired statistical data, the number of allocations of the advertisement requests to be allocated to each of the advertisement distribution devices. Then, the advertisement distribution management device 100 sends, to each of the advertisement distribution devices on the basis of the determined number of allocations, the advertisement requests that have been accepted from the terminal device 10.

In the embodiment, the statistical data related to the profit expected values are described as the average eCPM; however, the statistical data does not always need to be the average eCPM but may also be, for example, a click through rate (CTR), a conversion rate (CVR), or the like.

A process performed by the advertisement distribution management device 100 will be described with reference to FIG. 1A. First, the advertisement distribution management device 100 predicts the total of the number of advertisement requests to be accepted from one or more of the terminal devices 10 within a predetermined time period (Step 11). In a description below, the number of advertisement requests predicted by the advertisement distribution management device 100 may sometimes be referred to as “the number of predicted advertisement requests”. Furthermore, the predetermined time period mentioned here is, for example, from 12:00 to 13:00 (between 12:00 and 13:00) on Dec. 1, 2014 and may arbitrary be set to the advertisement distribution management device 100. Furthermore, the timing at which prediction is performed may also arbitrarily be set to the advertisement distribution management device 100.

For example, it is assumed that the advertisement distribution management device 100 has predicted “200” as the number of advertisement requests that is to be accepted from 12:00 to 13:00 (between 12:00 and 13:00) on Dec. 1, 2014. Here, the advertisement distribution management device 100 allocates the number of advertisement requests “200” that is a prediction result to the advertisement distribution devices A to C. At this time, the advertisement distribution management device 100 determines the number of advertisement requests “200” to be allocated to each of the advertisement distribution devices such that the profit obtained from each of the advertisement distribution devices is improved (Step S12).

Here, the determination process performed at Step 12 will be described with reference to FIG. 1B. FIG. 1B is a schematic diagram illustrating an example of information stored in a storing unit in the advertisement distribution management device 100. FIG. 1B indicates an example of the average eCPM associated with each of the number of advertisement requests per unit time (one hour in the example illustrated in FIG. 1B) in each of advertisement distribution devices. The eCPM is a profit expected value in units of 1000 impressions. By distributing advertising content to the advertisement distribution device in which eCPM is high, the profit of the administrator of the advertisement distribution device is improved; therefore, the profit of the administrator X of the advertisement distribution management device 100 obtained from a part of the sales from the administrator of the subject advertisement distribution device is improved.

Here, the average eCPM with respect to the number of advertisement requests per unit time mentioned here is the average eCPM that is calculated by using the eCPM that is obtained on the basis of a distribution track record of each of the pieces of the advertising content. For example, in FIG. 1B, the average eCPM with respect to the number of advertisement requests “50” per unit time in the advertisement distribution device 30A is “0.24”. Namely, this indicates that the average eCPM of each of the pieces of the advertising content distributed when the advertisement distribution device 30A has accepted 50 advertisement requests in one hour is “0.24”.

Furthermore, in FIG. 1B, when focusing on the number of advertisement requests “50” per unit time, the average eCPM of the advertisement distribution device 30C is “0.26”, which is the highest. Namely, in a case of the process of 50 advertisement requests in one hour, the highest advertisement expenses is expected to be obtained from the advertisement distribution device 30C that can distribute the advertising content with the average eCPM of “0.26”. Then, when focusing on the number of advertisement requests “100” per unit time, the average eCPM of the advertisement distribution device 30A is “0.21”, which is the highest. Namely, in a case of processing the advertisement requests of “100” in one hour, the highest advertisement expense is expected to be obtained from the advertisement distribution device 30A that can distribute the advertising content with the average eCPM of “0.21”. To obtain a higher advertisement expense leads to improving the profit of the administrator X of the advertisement distribution management device 100 that receives a part of the subject advertisement expense. Accordingly, by taking into consideration of this, the advertisement distribution management device 100 according to the first embodiment determines, from among the number of predicted advertisement requests, the number of allocations to be allocated to each of the advertisement distribution devices.

For example, when the number of predicted advertisement requests “50” is allocated to each of the advertisement distribution devices, “50” is preferably allocated to the advertisement distribution device 30C that has the highest average eCPM. Furthermore, when the number of predicted advertisement requests “100” is allocated to each of the advertisement distribution devices, “50” is preferably allocated to each of the advertisement distribution device 30A and the advertisement distribution device 30C. Furthermore, the number of predicted advertisement requests “150” is allocated to each of the advertisement distribution devices, “50” is preferably allocated to each of the advertisement distribution devices 30A to 30C.

Furthermore, as described above, when the number of predicted advertisement requests “200” is allocated to each of the advertisement distribution devices, if the number of predicted advertisement requests is “100”, because the advertisement distribution device 30A can perform advertisement distribution with the highest average eCPM of “0.21”, it is preferable to allocate the advertisement requests of “100” to the advertisement distribution device 30A, “50” to the advertisement distribution device 30B, and “50” to the advertisement distribution device 30C. Namely, in the example illustrated in FIG. 1B, the advertisement distribution management device 100 determines, from among the number of predicted advertisement requests of “200”, the number of allocations to be allocated to each of the advertisement distribution devices 30A to 30C is “100” to the advertisement distribution device 30A, “50” to the advertisement distribution device 30B, and “50” to the advertisement distribution device 30C, respectively. The number of allocations described here is an example and the number of advertisement requests other than the number of these allocations may also be allocated to each of the advertisement distribution devices.

A description will be given here by referring back to FIG. 1A, the distribution process of advertising content performed by the advertisement distribution management device 100 will be described. First, the terminal device 10 sends, in accordance with the operation of a user U10, a page request that requests-a web page W10 to the web server 20 (Step S13). The web server 20 sends the web page W10 to the terminal device 10 in accordance with the page request received from the terminal device 10 (Step S14).

If the terminal device 10 receives the web page W10 from the web server 20, the terminal device 10 sends an advertisement request to the advertisement distribution management device 100 (Step 15). For example, as illustrated in FIG. 1A, because an advertising space F10 is set on the web page W10, the terminal device 10 sends, to the advertisement distribution management device 100, the advertisement request that is a request to distribute the advertising content to be displayed on the advertising space F10.

Every time the advertisement distribution management device 100 accepts an advertisement request from the terminal device 10, the advertisement distribution management device 100 sends, on the basis of the number of allocations of the advertisement requests determined by the determination process, the accepted advertisement request to each of the advertisement distribution devices (Step S16). For example, the advertisement distribution management device 100 sends the advertisement requests to be accepted from 12:00 to 13:00 (between 12:00 and 13:00) on Dec. 1, 2014 such that the number of advertisement requests processed by each of the advertisement distribution device during that time period becomes “100” for the advertisement distribution device 30A, “50” for the advertisement distribution device 30B, and “50” for the advertisement distribution device 30C.

In this way, by sending the advertisement requests to each of the advertisement distribution devices, the advertisement distribution management device 100 allows the advertising content, which is in accordance with the advertisement requests, to be distributed (Step S17). In the example illustrated in FIG. 1A, the advertisement distribution management device 100 accepts the advertising content distributed from each of the advertisement distribution devices and distributes the accepted advertising content to the terminal device 10 (Step 18). Thus, the terminal device 10 displays the advertising content on the advertising space F10. Furthermore, the advertising content may also directly be distributed from each of the advertisement distribution devices to the terminal device 10 without passing through the advertisement distribution management device 100.

As described above, the advertisement distribution management device 100 predicts the number of advertisement requests to be accepted from the terminal device 10 within the predetermined time period. Then, the advertisement distribution management device 100 determines, on the basis of the average eCPM of each of the number of advertisement requests of each of the advertisement distribution device per unit time, the number of allocations allocated to each of the advertisement distribution devices from among the number of predicted advertisement requests. Furthermore, when the advertisement distribution management device 100 actually accepts an advertisement request from the terminal device 10, the advertisement distribution management device 100 allows each of the advertisement distribution devices to distribute the advertising content by sending, on the basis of the determined number of allocations, the advertisement requests to each of the advertisement distribution devices. Consequently, because the advertisement distribution management device 100 can improve the profit of each of the advertisement distribution devices obtained from the distribution of the advertising content, the advertisement distribution management device 100 can improve the profit of the administrator of the advertisement distribution management device 100.

In FIGS. 1A and 1B, by focusing on the average eCPM of each of the advertisement distribution devices, an example of determining the number of advertisement requests to be allocated to each of the advertisement distribution devices has been described. However, in addition to the average eCPM, the advertisement distribution management device 100 may also determine the number of allocations by taking into account an advertisement request being rejected by each of the advertisement distribution devices. In the following, a description will be given of a case in which the advertisement distribution management device 100 takes into account a process rejection rate (passback rate) that is the rate at which an advertisement request is rejected by each of the advertisement distribution devices.

### 2. Configuration of the Advertisement Distribution System

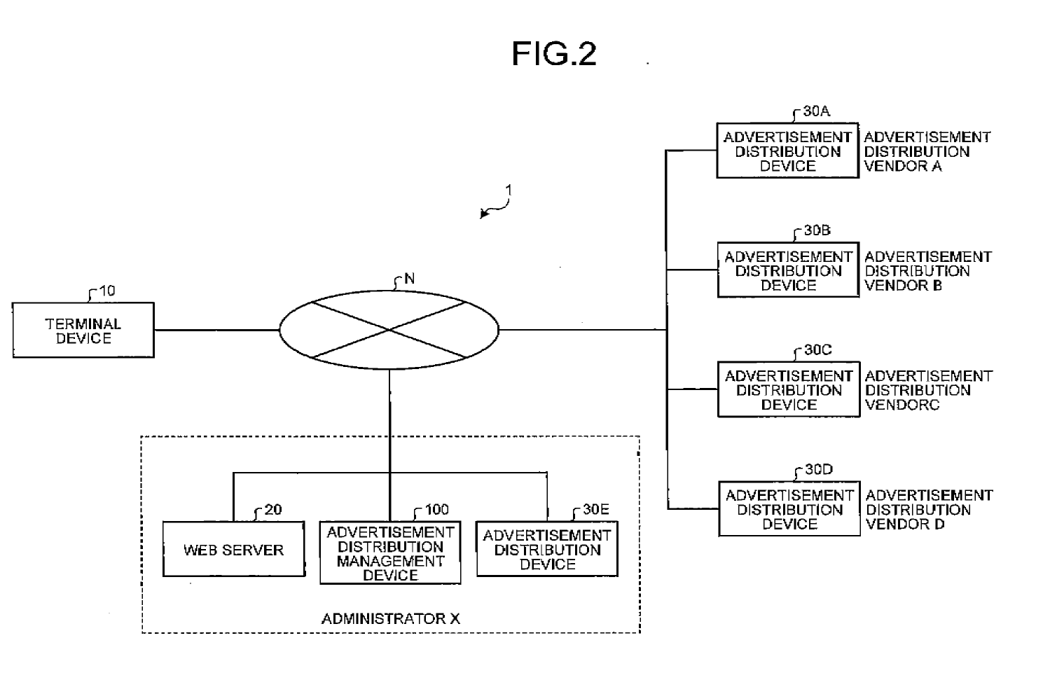

In the following, the configuration of the advertisement distribution system according to the first embodiment will be described with reference to FIG. 2. FIG. 2 is a schematic diagram illustrating a configuration example of an advertisement distribution system 1 according to the first embodiment. As illustrated in FIG. 2, the advertisement distribution system 1 includes the terminal device 10, the web server 20, the advertisement distribution devices 30A to 30E, and the advertisement distribution management device 100. The terminal device 10, the web server 20, the advertisement distribution devices 30A to 30E, and the advertisement distribution management device 100 are connected via a communication network N with each other such that they can communicate with each other by using wired connection or wireless connection. Furthermore, the advertisement distribution system 1 illustrated in FIG. 2 may also include a plurality of the terminal devices 10 or a plurality of the web servers 20 may also be included. Furthermore, the number of the advertisement distribution devices is not limited to 5.

The terminal device 10 is an information processing apparatus that is used by a user. For example, the terminal device 10 is a mobile phone, such as a smart phone or the like, a tablet terminal, a personal digital assistant (PDA), a desktop type personal computer (PC), a notebook PC, or the like, and a browser application (hereinafter, sometimes referred to as a “browser”) is installed.

The web server 20 stores therein a plurality of web pages in each of which an advertising space is set. If the web server 20 is accessed from the browser in the terminal device 10 via the communication network N, the web server 20 provides a web page associated with the uniform resource locater (URL) specified by the terminal device 10.

When the browser in the terminal device 10 receives a web page from the web server 20, the browser sends, to the advertisement distribution management device 100, the advertisement request associated with the advertising space that is set in the web page. The advertisement request includes, for example, identification information on the user U10 of the terminal device 10 (hereinafter, sometimes referred to as a “user ID”) or identification information on an advertising space (hereinafter, sometimes referred to as an “advertising space ID”). The user ID is, for example, a hyper text transfer protocol (HTTP) cookie. In this HTTP cookie, user information, such as age, sex, or the like, about the user U10 may also be included, in addition to the user ID.

The advertisement distribution device 30A, the advertisement distribution device 30B, the advertisement distribution device 30C, the advertisement distribution device 30D, and the advertisement distribution device 30E are managed and operated by the advertisement distribution vendor A, the advertisement distribution vendor B, the advertisement distribution vendor C, the advertisement distribution vendor D, and the administrator X, respectively. Furthermore, the web server 20 and the advertisement distribution management device 100 are also managed and operated by the administrator X.

Each of the advertisement distribution devices described above distributes advertising content in accordance with an advertisement request received from the advertisement distribution management device 100. Then, the system that includes the advertisement distribution devices and that distributes the advertising content to the terminal device 10 via the communication network N is referred to as an ad network. Namely, in FIG. 2, five ad networks including the advertisement distribution devices 30A to 30E are illustrated.

By sending the advertisement requests to the advertisement distribution devices 30A to 30D, the advertisement distribution management device 100 requests to distribute the advertising content; however, there may be a case in which these advertisement distribution devices reject a process of an advertisement request (distribution of the advertising content in accordance with the advertisement request). Such rejection of the advertisement request by the advertising content distribution device is referred to as a passback or the like.

For example, the advertisement distribution management device 100 sends, to the advertisement distribution devices 30A to 30D, an advertisement request to distribute the advertising content that has a predetermined eCPM. Then, it is assumed that the advertisement distribution management device 100 has intensively sent, within a predetermined time period, advertisement requests to distribute advertising content with, for example, eCPM of “0.15 to 0.20”. In this case, there may be a case in which each of the advertisement distribution devices is not able to distribute the advertising content with the eCPM of “0.15 to 0.20” due to a rapid decrease in or depletion of the advertising content with the eCPM of “0.15 to 0.20” from among the advertisement inventory of each of the advertisement distribution devices. Consequently, each of the advertisement distribution devices is not able to distribute the advertising content targeted for the advertisement requests and passes back the subject advertisement requests to the advertisement distribution management device 100 that is the transmission source.

However, the example is not limited to the above and there may be a case in which the number of advertisement requests that can be processed per unit time by the advertisement distribution devices 30A to 30D may also be set. In such a case, the advertisement distribution devices 30A to 30D pass back the excessively received advertisement requests that can be processed.

Furthermore, the passback rate of each of the advertisement distribution devices is calculates as the rate of the number of times of passback performed by each of the advertisement distribution devices within the predetermined time period with respect to the number of advertisement requests sent from the advertisement distribution management device 100 to each of the advertisement distribution devices within the predetermined time period.

Furthermore, the advertisement distribution management device 100 allows the advertisement distribution device 30E to perform advertisement distribution in accordance with the passed back advertisement requests. In this way, by sending the advertisement requests to the advertisement distribution devices 30A to 30D that are managed by the other vendors, the advertisement distribution management device 100 that is used by the administrator X allows the advertisement distribution device 30E to distribute the advertising content to the advertisement distribution devices 30A to 30D with priority and to perform the advertisement distribution in accordance with the advertisement requests that were passed back from these advertisement distribution devices. Namely, the administrator X allows, by using the advertisement distribution management device 100, the advertisement distribution devices 30A to 30D that are the other vendors to distribute the advertising content, thereby obtaining a part of the sales of the advertisement distribution device as profit and allows, by using the advertisement distribution management device 100, the advertisement distribution device 30E, i.e. the own device, to distribute the advertising content, thereby obtaining profit from an advertiser.

Furthermore, it is assumed that the number of advertisement requests that can be processed by the advertisement distribution device 30E per unit time (for example, one hour) has been determined. For example, if the number of advertisement requests that are passed back exceeds its upper limit, an advertisement request that is not able to be processed by the advertisement distribution device 30E occurs. However, because no device that performs the advertisement distribution in accordance with such an advertisement request is present, there may consequently be a case in which the advertising content is not displayed on an advertising space on a web page. Accordingly, the advertisement distribution management device 100 according to the first embodiment also takes into account the passback rate of each of the advertisement distribution devices, sets the number of advertisement requests that can be processed by the advertisement distribution device 30E to the constraint condition, and determines the number of allocations that is allocated to the advertisement distribution devices 30A to 30D and in which the profit of the administrator X is improved.

### 3. Configuration of the Advertisement Distribution Management Device

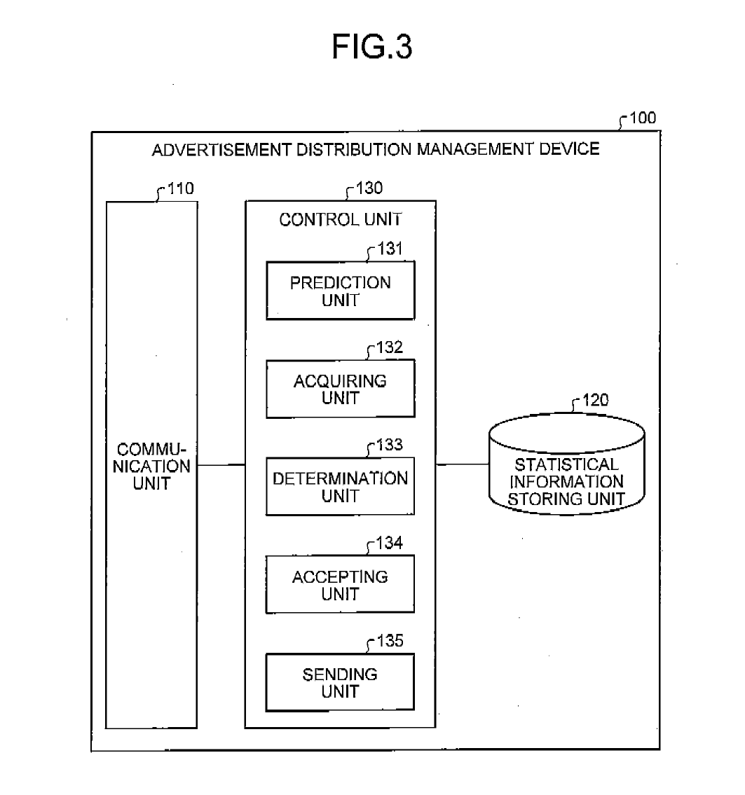

In the following, the advertisement distribution management device 100 according to the first embodiment will be described with reference to FIG. 3. FIG. 3 is a schematic diagram illustrating a configuration example of an advertisement distribution management device 100 according to the first embodiment. As illustrated in FIG. 3, the advertisement distribution management device 100 includes a communication unit 110, a statistical information storing unit 120, and a control unit 130.

The communication unit 110 is a communication interface that sends and receives information between the communication network N and connects to the communication network N by using wired connection or wireless connection.

### (About Statistical Information Storing Unit 120)

The statistical information storing unit 120 is implemented by, for example, a semiconductor memory device, such as a random access memory (RAM), a flash memory, and the like, or a storage device, such as a hard disk, an optical disk, and the like.

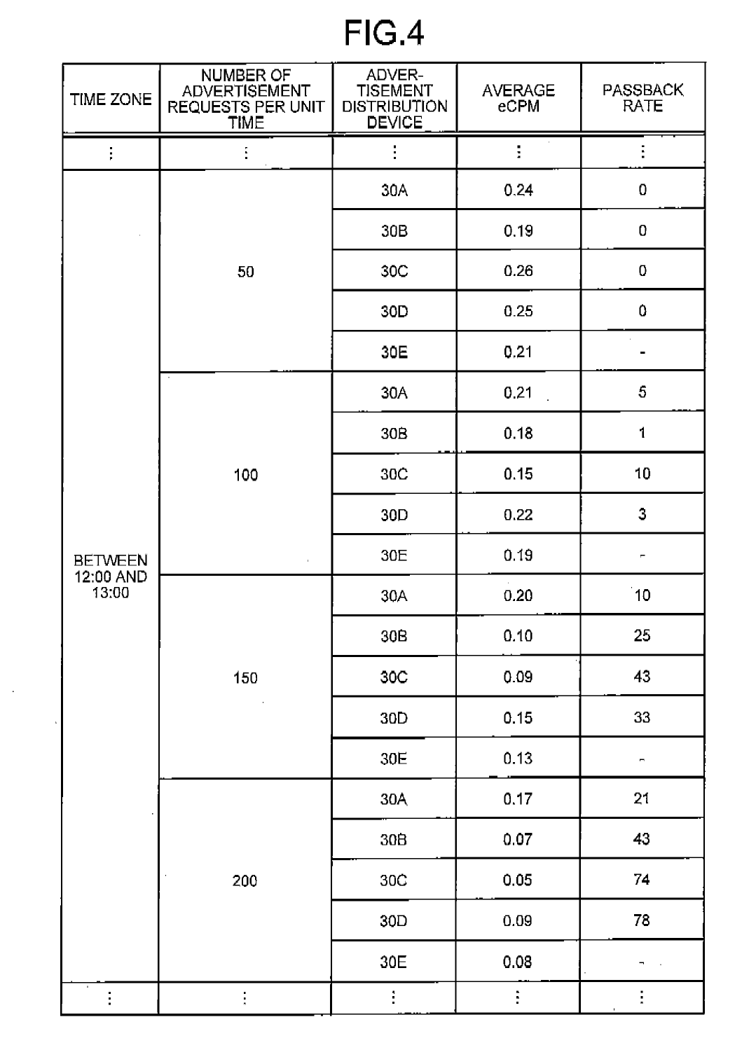

The statistical information storing unit 120 stores therein, for each time zone and for each number of advertisement requests sent to each of the advertisement distribution devices per unit time, the average eCPM and the passback rate of the advertising content distributed by each of the advertisement distribution devices in accordance with the advertisement requests. Here, FIG. 4 is a schematic diagram illustrating an example of the statistical information storing unit 120 according to the first embodiment. In the example illustrated in FIG. 4, the statistical information storing unit 120 has items, such as the “time zone”, the “number of advertisement requests per unit time”, the “advertisement distribution device”, the “average eCPM”, and the “passback rate”.

The “time zone” indicates each of the time zones every one hour. The example illustrated FIG. 4 indicates a time between 12:00 and 13:00; however, in practice, the statistical information storing unit 120 has the data for each time zone for 24 hours between 0:00 and 23:00. Furthermore, as the “the number of advertisement requests per unit time”, the values, such as 50, 100, 150, 200, and . . . are indicated; however, these values are examples and may also arbitrarily be set. For example, the values at intervals of 10, such as 10, 20, and 30, may also be set. Furthermore, in the embodiment, it is assumed that the unit time is one hour; however, the unit time is not limited thereto. For example, the unit time may also be 30 minutes. The “advertisement distribution devices” are associated with the advertisement distribution devices 30A to 30E illustrated in FIG. 2.

The “average eCPM” is an average eCPM that is calculated, for each number of advertisement requests, by using the eCPM based on the distribution track record of the advertising content distributed by each of the advertisement distribution devices in accordance with an advertisement request.

For example, in the example illustrated in FIG. 4, the average eCPM in the advertisement distribution device 30A with respect to the number of advertisement requests of “50” per one hour at a time between 12:00 and 13:00 is “0.24”. This indicates that the average value of the eCPM of each of the pieces of the advertising content distributed when 50 advertisement requests are accepted by the advertisement distribution device 30A in one hour between 12:00 and 13:00 is “0.24”. Furthermore, such an average eCPM may also be calculated on the basis of the advertising content that was distributed on a certain single day or distributed during one week instead of a single day. Namely, calculation may also be performed on the basis of the advertising content that was distributed in an arbitrary time period. Furthermore, the average eCPM is calculated by each of the advertisement distribution devices and is sent as statistical data to the advertisement distribution management device 100.

Then, the advertisement distribution vendors A to D periodically provide the administrator X who is the trading partner with such statistical data as a distribution track record. For example, the advertisement distribution vendors A to D send, by using their own advertisement distribution device, the statistical data to the advertisement distribution management device 100. Furthermore, the advertisement distribution management device 100 may also acquire the statistical data from each of the advertisement distribution devices.

The “passback rate” indicates the rate of the number of passbacks with respect to the number of advertisement requests per unit time. Specifically, the passback rate is calculated as the ratio of the number of passbacks from each of the advertisement distribution devices to the number of advertisement requests that are sent from the advertisement distribution management device 100 to each of the advertisement distribution devices per unit time. Furthermore, by subtracting the number of pieces of the advertising content distributed by each of the advertisement distribution devices from the number of advertisement requests that are sent, the advertisement distribution management device 100 may also count the number of passbacks of each of the advertisement distribution devices or may also set the number of passed back advertisement requests as the number of passbacks.

Namely, the example illustrated in FIG. 4 indicates that, for example, if the advertisement distribution device 30A accepts the number of advertisement requests of “100” at a time between 12:00 and 13:00, the advertisement distribution device 30A tends to passback “5” advertisement requests that are the result obtained by multiplying the passback rate “5%” by the number of advertisement requests “100”.

About the Control Unit 130

The control unit 130 is implemented by, for example, a central processing unit (CPU), a micro processing unit (MPU), or the like, executing various kinds of programs (corresponding to an example of an advertisement distribution management program), which is stored in a storage device in the advertisement distribution management device 100, by using a RAM as a work area. Furthermore, the control unit 130 is implemented by, for example, an integrated circuit, such as an application specific integrated circuit (ASIC), a field programmable gate array (FPGA), or the like.

As illustrated in FIG. 3, the control unit 130 includes a prediction unit 131, an acquiring unit 132, a determination unit 133, an accepting unit 134, and a sending unit 135 and implements or executes the function performed by the information processing described below. The internal configuration of the control unit 130 is not limited to the configuration illustrated in FIG. 3 and may also be another configuration as long as the configuration in which the information processing, which will be described later, is performed is included. Furthermore, the connection relation among each of the processing units included in the control unit 130 is not limited to the connection relation illustrated in FIG. 3, and another connection relation may also be used.

About the Prediction Unit 131

The prediction unit 131 predicts the number of advertisement requests to be accepted from the terminal device 10 in a predetermined time period. Specifically, the prediction unit 131 predicts, on the basis of the acceptance history of the advertisement requests accumulated until the current time point, the number of advertisement requests to be accepted from the terminal device 10 in a predetermined time period. For example, if the predetermined time period is the “time between 12:00 and 13:00 on Dec. 1, 2014”, the prediction unit 131 predicts, at predetermined timing from the reception history, the number of advertisement requests accepted from the terminal device 10 in this time zone. Any timing may also be used for the timing at which the prediction unit 131 predicts as long as the time is before the predetermined time period targeted for the prediction. Then, the prediction unit 131 outputs the number of predicted advertisement requests to the acquiring unit 132.

About the Acquiring Unit 132

The acquiring unit 132 acquires data from the statistical information storing unit 120. Specifically, if the acquiring unit 132 accepts the number of predicted advertisement requests from the prediction unit 131, the acquiring unit 132 acquires, on the basis of the number of the accepted and predicted advertisement requests, for each number of advertisement requests that were sent to the advertisement distribution device per unit time, the average eCPM of the advertising content distributed by the advertisement distribution device in accordance with the subject advertisement request. Furthermore, the acquiring unit 132 acquires, on the basis of the accepted number of predicted advertisement requests, the passback rate of the advertisement distribution device.

For example, if the prediction unit predicts that the number of advertisement requests to be accepted from the terminal device 10 at the “time between 12:00 and 13:00 on Dec. 1, 2014”, the acquiring unit 132 allocates, for the predicted number of advertisement requests of “200”, an arbitrary value to each of the advertisement distribution devices 30A to 30D and acquires the average eCPM and the passback rate of each of the advertisement distribution devices 30A to 30D associated with the allocated value and the “time between 12:00 and 13:00 on Dec. 1, 2014”.

The acquiring unit 132 acquires, by using various patterns as combinations of arbitrary number of allocations, the average eCPM and the passback rate of the advertisement distribution devices 30A to 30D associated with each pattern. As will be described later, the determination unit 133 determines, as the number of allocations, a pattern in which the total of the profit expected value from the advertisement distribution devices 30A 30E is the maximum from among these pattern.

Furthermore, the acquiring unit 132 periodically acquires the average eCPM from each of the advertisement distribution devices and stores the acquired average eCPM in the statistical information storing unit 120. Furthermore, the average eCPM may also be sent from each of the advertisement distribution devices and, in this case, the acquiring unit 132 stores the average eCPM received from each of the advertisement distribution devices in the statistical information storing unit 120.

About the Determination Unit 133

The determination unit 133 determines, on the basis of the average eCPM and the passback rate acquired by the acquiring unit 132, the number of allocations of the advertisement requests to be allocated to each of the advertisement distribution devices 30A to 30D. Specifically, the advertisement distribution management device 100 determines, by using Expressions (1) and (2), a profit expected value, which is obtained when the advertisement distribution devices 30A to 30D distribute the advertising content in a predetermined time zone, and the number of allocations, in which the total of the profit expected value that is obtained when the advertisement distribution device 30E distributes the advertising content in accordance with the advertisement requests passed back from the advertisement distribution devices 30A to 30D, becomes the maximum.

Σₐ{R(a,t)×P(a,t,r)}≦R(t) (1)

Σₐ[{1−P(a,t,r)}×R(a,t)×E(a,t,r)]+[Σₐ{R(a,t)×P(a,t,r)}]×F(t,r) (2)

Here, in Expression (1), the symbol “a” is information that identifies the advertisement distribution devices 30A to 30D. The symbol “t” is information that identifies a time zone. Namely, the symbol R(a, t) indicates the number of allocations that is the number of planned allocations in which advertisement request is allocated to the advertisement distribution device “a” in the time zone “t”.

Furthermore, the symbol “r” indicates the number of advertisement requests based on the distribution track record in the time zone “t”. For example, the symbol “r” corresponds to “the number of advertisement requests per unit time” illustrated in FIG. 4. Namely, the symbol P(a, t, r) indicates the passback rate obtained when the number of advertisement requests “r” is allocated to the advertisement distribution device “a” in the time zone “t”. Namely, the symbol R(a, t)□P(a, t, r) indicates the number of passbacks obtained due to the number of advertisement requests “r” is allocated to the advertisement distribution device “a” in the time zone “t”.

Furthermore, the symbol of R(t) indicates the upper limit of the number of advertisement requests that can be processed by the advertisement distribution device 30E in the time zone “t”. Namely, Expression (1) indicates constraint condition that constraints the sum total of the number of passbacks of the advertisement distribution devices 30A to 30D in the time zone “t” such that the sum total does not exceed the upper limit of the number of advertisement requests that can be processed by the advertisement distribution device 30E in the time zone “t”.

In the following, Expression (2) will be described. The symbol “1−P(a, t, r)” indicates the ratio of the number of advertisement requests, from among the number of advertisement requests “r”, that can be processed by the advertisement distribution device “a” in the time zone “t”. Furthermore, the symbol E(a, t, r) indicates the average eCPM associated with the number of advertisement requests “r” in the advertisement distribution device “a” in the time zone “t”. Namely, because {1−P(a, t, r)}□R(a, t)□E(a, t, r) corresponds to the sum total of the eCPM of the advertising content distributed by the advertisement distribution device “a” in accordance with the advertisement requests of “r” that are sent to the advertisement distribution device “a” in the time zone “t”, the determination unit 133 calculates the value corresponding to the sum total of the eCPM of the advertisement distribution devices 30A to 30D.

Furthermore, the determination unit 133 calculates, on the basis of R(a, t)□P(a, t, r), a value corresponding to the sum total of the number of passbacks of the advertisement distribution devices 30A to 30D with respect to the number of advertisement requests “r” in time zone “t”. Then, because F(t, r) indicates the average eCPM with respect to the number of advertisement requests “r” in the advertisement distribution device 30E in the time zone “t”, by multiplying these values, the determination unit 133 calculates a value corresponding to the sum total of the eCPM of the advertising content distributed by the advertisement distribution device 30E in the time zone “t”.

Because of the above, Expression (2) is the objective function indicating the total of the sum total of the eCPM of the advertising content distributed by the advertisement distribution devices 30A to 30D in the time zone “t” and the sum total of the eCPM of the advertising content distributed by the advertisement distribution device 30E in the time zone “t”. Thus, the determination unit 133 determines, under the constraint condition of Expression (1), Expression (2), i.e., R(a, t) in which the total of the eCPM all of the pieces of advertising content distributed by the advertisement distribution devices 30A to 30E in the time zone “t” becomes the maximum. Furthermore, the determination unit 133 may also store the calculated number of allocations R(a, t) in a predetermined storing unit (for example, a buffer).

About the Accepting Unit 134

The accepting unit 134 accepts an advertisement request from the terminal device 10. Then, the accepting unit 134 outputs the accepted advertisement request to the sending unit 135. In the advertisement request, a user ID or the like is included in the terminal device 10.

About the Sending Unit 135

By sending the advertisement request accepted by the accepting unit 134 to the advertisement distribution device, the sending unit 135 allows the advertisement distribution device that is the transmission destination to distribute the advertising content. Specifically, the sending unit 135 sends advertisement requests to the advertisement distribution devices 30A to 30D on the basis of the number of allocations of R(a, t) associated with the time zone at which the advertisement requests are accepted. Regarding the transmission of the advertisement requests performed by the sending unit 135, the following process can be conceived.

For example, the sending unit 135 intensively sends the accepted advertisement requests to a predetermined single advertisement distribution device from among the advertisement distribution devices, thus, at the time point at which the number of allocations with respect to the subject advertisement distribution device is satisfied, repeatedly performing the process of intensively allocating the advertisement requests to the subsequent advertisement distribution device until the number of allocations is satisfied. At this time, as the selection of the advertisement distribution devices, for example, the advertisement distribution devices may also be selected in the order in which the average eCPM illustrated in FIG. 4 is large or may also randomly be selected. Furthermore, the sending unit 135 may also disperse the transmission of the advertisement requests on the basis of the proportion of the number of allocations of each of the advertisement distribution devices. Furthermore, by accepting the advertisement requests passed back from the advertisement distribution devices 30A to 30D, the sending unit 135 calculates a passback rate and stores the calculated passback rate in the statistical information storing unit 120.

### 4. Flow of the Advertisement Distribution Process

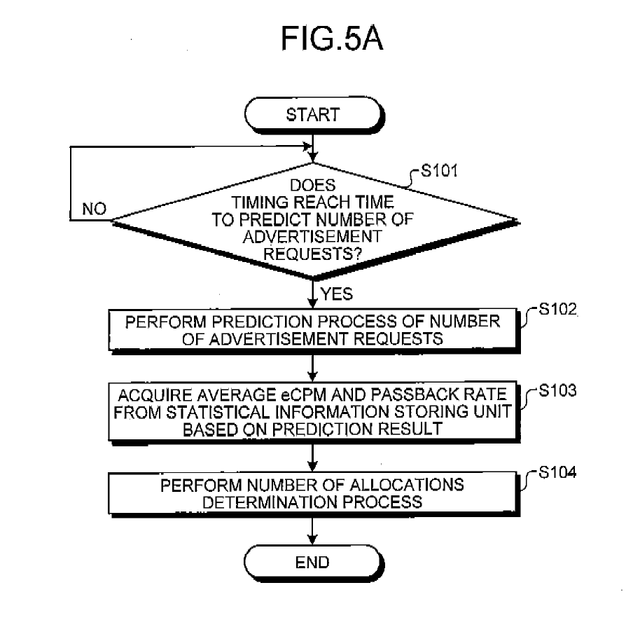

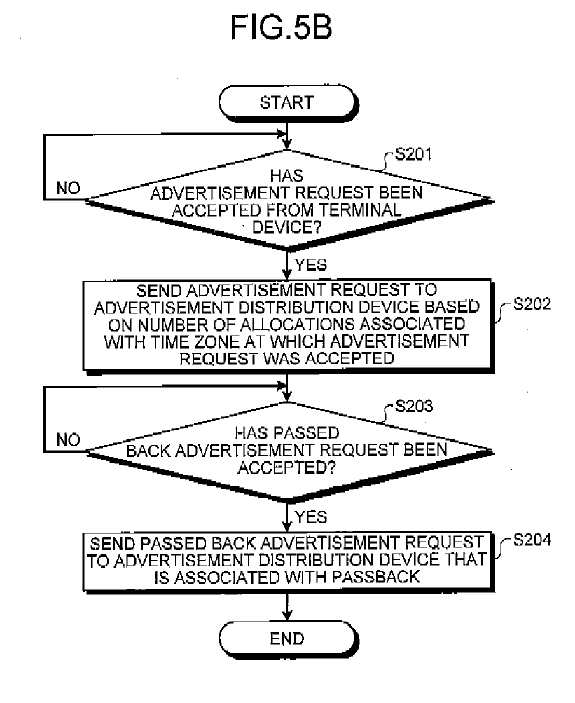

In the following, the flow of a process performed by the advertisement distribution system 1 according to the first embodiment will be described with reference to FIGS. 5A and 5B.

4-1. Flow of the Number of Allocations Determination Process

First, the flow of a determination process of the number of allocations performed by the advertisement distribution management device 100 according to the first embodiment will be described with reference to FIG. 5A. FIG. 5A is a flowchart illustrating the flow of a number of allocations determination process performed by the advertisement distribution management device 100 according to the first embodiment.

As illustrated in FIG. 5A, the prediction unit 131 in the advertisement distribution management device 100 determines whether the timing reaches the time to predict the number of advertisement requests that are accepted from the terminal device 10 within a predetermined time period (Step S101). The prediction timing may also arbitrarily and previously be set with respect to the advertisement distribution management device 100 and set in combination of, for example, the date, a day of the week, the time, or the like. Then, if the prediction unit 131 determines that the timing is the prediction timing (Yes at Step S101), the prediction unit 131 starts a prediction process and sends a prediction result to the acquiring unit 132 (Step S102). In contrast, if the prediction unit 131 determines that the timing is not the prediction timing (No at Step S101), the prediction unit 131 waits until the timing reaches the prediction timing.

The acquiring unit 132 acquires data from the statistical information storing unit 120 (Step S103). Specifically, if the acquiring unit 132 accepts the number of predicted advertisement requests from the prediction unit 131, the acquiring unit 132 acquires, on the basis of the accepted number of predicted advertisement requests, for each number of advertisement requests that were sent to the advertisement distribution device per unit time, the average eCPM of the advertising content distributed by the advertisement distribution device in accordance with the subject advertisement requests. Furthermore, the acquiring unit 132 acquires, on the basis of the accepted number of predicted advertisement requests, the passback rate of the advertisement distribution device. Then, the acquiring unit 132 outputs the acquired average eCPM and the passback rate to the determination unit 133.

Then, the determination unit 133 determines, by using the data received from the acquiring unit 132, the number of allocations of the number of requests to be allocated to each of the advertisement distribution devices (Step S104). When the example illustrated in FIG. 2 will be described, by calculating using Expression (2) under the constraint condition that is indicated by Expression (1), the determination unit 133 determines the number of allocations with respect to the advertisement distribution devices 30A to 30D, in which the total of the sum total of the eCPM of the advertising content distributed by the advertisement distribution devices 30A to 30D during the subject predetermined time period and the sum total of the eCPM of the advertising content distributed by the advertisement distribution device 30E becomes the maximum.

4-2. Flow of the Distribution Process

Furthermore, the flow of the distribution process performed by the advertisement distribution management device 100 according to the first embodiment will be described with reference to FIG. 5B. FIG. 59 is a flowchart illustrating the flow of a distribution process performed by the advertisement distribution management device 100 according to the first embodiment.

As illustrated in FIG. 5B, the accepting unit 134 determines whether an advertisement request has been accepted from the terminal device 10 (Step S201). If the accepting unit 134 determines that the advertisement request has been accepted (Yes at Step S201), the accepting unit 134 outputs the advertisement request to the sending unit 135. In the advertisement request, for example, attribute information or the like, such as a user ID, an advertising space ID, and advertising space, is included. In contrast, if the accepting unit 134 determines that the advertisement request has not been accepted (No at Step S201), the accepting unit 134 waits until that the advertisement request is accepted.

Then, the sending unit 135 sends, on the basis of the number of allocations associated with the time zone at which the advertisement request was accepted, the advertisement request to the advertisement distribution device, thus allowing the advertisement distribution device that is the transmission destination to distribute the advertising content (Step S202).

Furthermore, the sending unit 135 determines whether a passed back advertisement request has been accepted (Step 203). If the sending unit 135 determines that a passed back advertisement request has been accepted (Yes at Step S203), the sending unit 135 sends the passed back advertisement request to the advertisement distribution device that is associated with the passback, thus allowing the advertising content to be distributed (Step S204). The advertisement distribution device associated with the passback indicates the advertisement distribution device that is managed together with the advertisement distribution management device 100 by a predetermined administrator. In contrast, if the sending unit 135 determines that a passed back advertisement request has not been accepted (No at Step S203), the sending unit 135 waits until a passed back advertisement request is accepted. Furthermore, processes at Steps S202 and S203 may also be simultaneously performed.

### 5. Modification

The advertisement distribution process according to the first embodiment may also be performed with various kinds of embodiments other than the embodiments described above. Therefore, another embodiment of the advertisement distribution process will be described below.

5-1. Determination Process

The first embodiment indicates an example in which, by using Expressions (1) and (2) above, the advertisement distribution management device 100 determines the number of allocations by taking into consideration the passback rate of each of the advertisement distribution devices. However, the advertisement distribution management device 100 may also determines the number of allocations without taking into consideration of the passback rate indicated by the example illustrated in FIG. 1. This point will be described below. Furthermore, an example of a case of not considering the passback rate is a case in which the administrator X of the advertisement distribution management device 100 does not have the own ad network (for example, the advertisement distribution device 30E illustrated in FIG. 2) that can handle the passback and, thus, obtains profit by allowing the advertisement distribution devices 30A to 30D to distribute advertising content by using only the advertisement distribution management device 100. This example is associated with the advertisement distribution system 1 illustrated in FIG. 1A.

As described above, because the passback rate is not considered, Expression (2) can be transformed to Expression (3). Namely, the determination unit 133 determines the number of allocations R(a, t) by calculating using Expression (3). Furthermore, because the advertisement distribution device associated with the passback is not present, the constraint condition is not used.

Σₐ[(R(a,t)×E(a,t,r)] (3)

Expression (3) is an objective function indicating the total of the profit expected values of the advertisement distribution devices obtained by allowing each of the advertisement distribution devices of the advertisement distribution devices 30A to 30C to distribute advertising content by using the number of allocations R(a, t) based on the number of prediction requests in the time zone “t”. Consequently, the advertisement distribution management device 100 calculates the number of allocations R(a, t) in which Expression (3) becomes the maximum value. Then, the advertisement distribution management device 100 sends, on the basis of the calculated number of allocations R(a, t), the advertisement requests accepted from the terminal device 10 in the time zone “t” to the advertisement distribution devices 30A to 30C and allows each of the advertisement distribution devices to distribute the advertising content.

Consequently, the advertisement distribution management device 100 can also provide another company of, for example, an administrator who does not have the own ad network with an advertising space and improve profit obtained by allowing the advertising content to be distributed.

### 6. Advantages

As described above, the advertisement distribution management device 100 according to the first embodiment includes the acquiring unit 132, the determination unit 133, and the sending unit 135. The acquiring unit 132 acquires, for each number of advertisement requests sent to an advertisement distribution device per unit time, a profit expected value of the advertising content distributed by the advertisement distribution device in accordance with an advertisement request. The determination unit 133 determines, on the basis of the profit expected value acquired by the acquiring unit 132, the number of allocations of the advertisement requests to be allocated to the advertisement distribution device. The sending unit 135 sends, on the basis of the number of allocations determined by the determination unit 133, a new advertisement request to the advertisement distribution device.

Consequently, because the advertisement distribution management device 100 according to the first embodiment can improve the profit obtained from, for example, the distribution of the advertising content performed by an advertisement distribution device in another company, the advertisement distribution management device 100 can improve the profit of the administrator of the advertisement distribution management device 100.

Furthermore, in the first embodiment, the acquiring unit 132 acquires a profit expected value for each advertisement distribution device and the determination unit 133 determines, on the basis of the profit expected value acquired by the acquiring unit 132, the number of allocations of the advertisement requests to be allocated for each advertisement distribution device.

Consequently, because the advertisement distribution management device 100 according to the first embodiment can determine the number of allocations of the advertisement requests to be allocated to a plurality of advertisement distribution devices, the advertisement distribution management device 100 can further improve the profit of the administrator of the advertisement distribution management device 100.

Furthermore, in the first embodiment, the acquiring unit 132 acquires the rejection rate that is the rate at which advertisement requests are rejected by the advertisement distribution device and the determination unit 133 determines, on the basis of the rejection rate acquired by the acquiring unit 132, the number of allocations of the advertisement requests to be allocated to the advertisement distribution device.

Consequently, by taking into account the passback rate of the advertisement requests from the advertisement distribution device, the advertisement distribution management device 100 according to the first embodiment can accurately determine the number of allocations that improves the profit of the administrator of the advertisement distribution management device 100.

Furthermore, in the first embodiment, the determination unit 133 determines the number of allocations on the basis of both the profit expected value that is acquired by the acquiring unit 132 and the profit expected value that is obtained when advertising content with respect to the advertisement request that is rejected by the advertisement distribution device is distributed by another advertisement distribution device that is other than the advertisement distribution device.

Consequently, by also taking into account the profit expected value obtained when the advertisement request that is passed back by the advertisement distribution device is allowed to be processed by the advertisement distribution device held by the administrator of the advertisement distribution management device 100, the advertisement distribution management device 100 according to the first embodiment can accurately determine the number of allocations that improves the profit of the administrator of the advertisement distribution management device 100.

### Second Embodiment

In the first embodiment described above, an example has been described in which the number of allocations of the advertisement requests with respect to each of the advertisement distribution devices is determined such that the profit obtained from each of the advertisement distribution devices is improved. Here, there may be a case in which an advertisement distribution management device 200 sends, to the advertisement distribution device, an advertisement request in which the price rank indicating the expected profit of the advertising content is set. In this case, the advertisement distribution device distributes the advertisement request associated with the price rank. In a second embodiment, a description will be given of an example of determining the number of allocations of advertisement requests for each price rank.

1. Advertisement Distribution Process

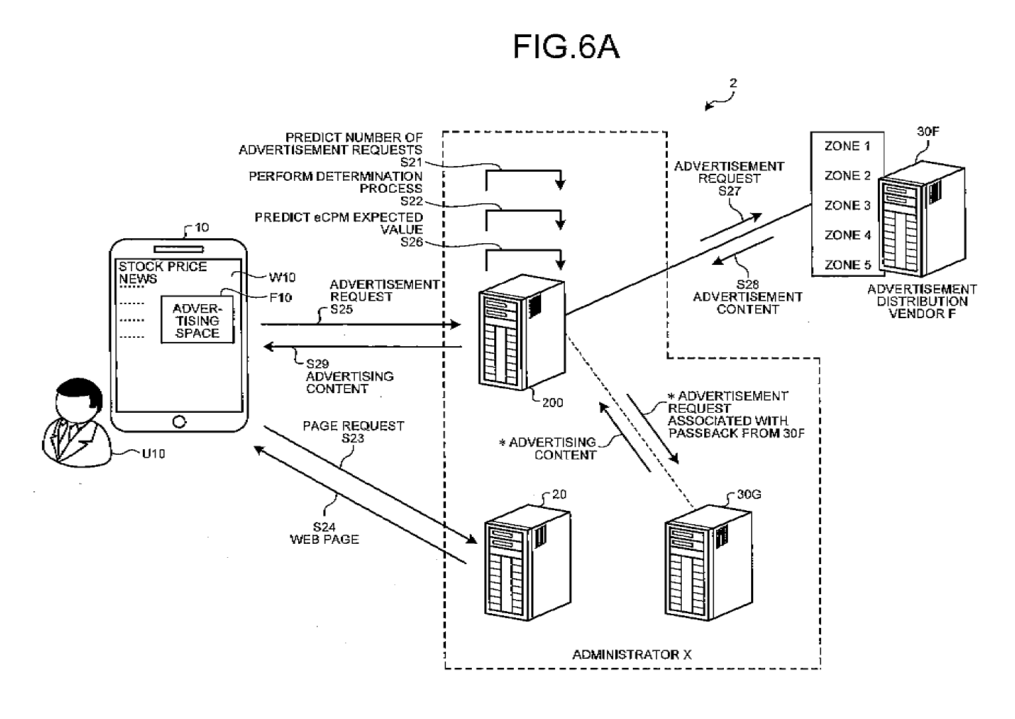

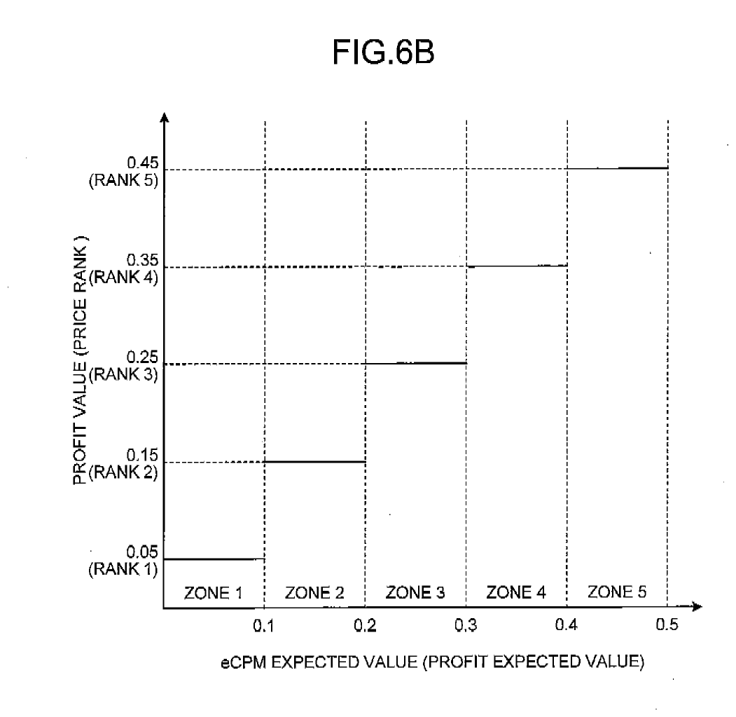

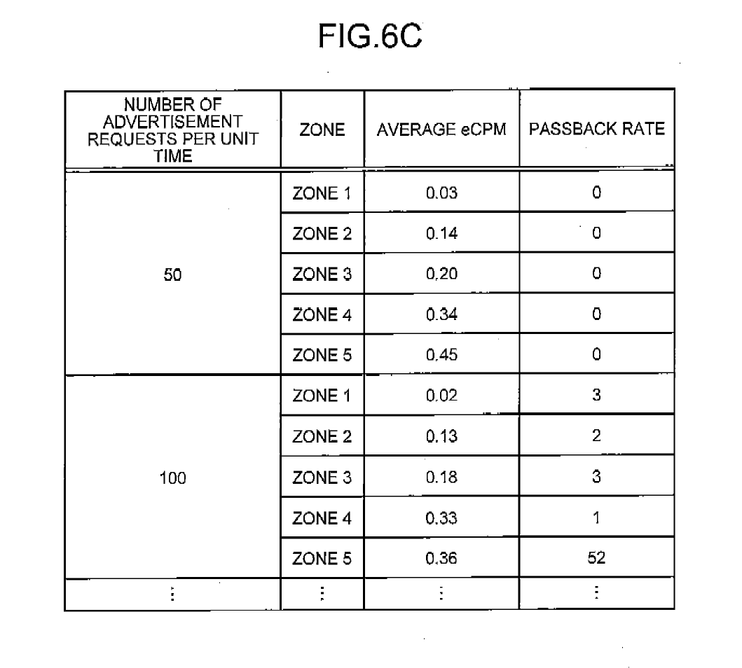

An example of an advertisement distribution process according to the second embodiment will be described with reference to FIGS. 6A to 6C. FIG. 6A is a schematic diagram illustrating an example of an advertisement distribution process according to a second embodiment. As illustrated in FIG. 6A, an advertisement distribution system 2 according to the second embodiment includes the web server 20, an advertisement distribution device 30F, an advertisement distribution device 30G, and the advertisement distribution management device 200. These devices are connected such that the devices can communicate with each other via a communication network. The web server 20, the advertisement distribution device 30G, the advertisement distribution management device 200 are managed and operated by the administrator X and the advertisement distribution device 30F is managed and operated by an advertisement distribution vendor F. Furthermore, in the advertisement distribution system 2 according to the second embodiment, a plurality of the terminal devices 10, a plurality of advertisement distribution vendors that is different from the administrator X, or a plurality of advertisement distribution devices managed by these advertisement distribution vendors may also be included.

Here, the advertisement distribution management device 200 requests the advertisement distribution device 30F to distribute the advertising content in accordance with the price rank that is set to the advertisement distribution device 30F. Specifically, for an advertisement request accepted from the terminal device 10, the advertisement distribution management device 200 predicts a profit expected value that is obtained when the advertising content is distributed by the advertisement distribution device 30G that is the own device of the administrator X. In the second embodiment, it is assumed that the profit expected value is eCPM expected by the distribution of the advertising content with respect to the advertisement request (hereinafter, sometimes referred to as an “eCPM expected value”). Then, the advertisement distribution management device 200 requests the advertisement distribution device 30F to distribute the advertising content at the price rank that is associated with the eCPM expected value.

This point will be described with reference to FIG. 6B. FIG. 6B is a schematic diagram illustrating an example of price terms due to a price terms table stored in a storing unit in the advertisement distribution management device 200. As illustrated in FIG. 6B, under the price terms according to the price terms table, the relationship between the eCPM expected value in the advertisement distribution device 30G and the price rank submitted to the advertisement distribution device 30F is indicated.

In the example illustrated in FIG. 6B, if the eCPM expected value is included in a “Zone 1”, the price rank of “Rank 1” is set and, if the eCPM expected value is included in a “Zone 2”, the price rank of “Rank 2” is set. Furthermore, if the eCPM expected value is included in a “Zone 3”, the price rank of “Rank 3” is set and, if the eCPM expected value is included in a “Zone 4”, the price rank of “Rank 4” is set and, if the eCPM expected value is included in a “Zone 5”, the price rank of “Rank 5” is set.

The price rank is indicated as, for example, a profit value. Such a profit value is set on the basis of the eCPM expected value described above. For example, the price rank preferably be set in the price terms table such that the profit obtained by the administrator X from the advertisement distribution device 30F becomes the profit that is equal to or greater than the profit expected value obtained by the advertisement distribution device 30G in its own company. Based on this, the profit value as the price rank illustrated in FIG. 6B is set such that the average value of the eCPM expected values for each Zone is set as the profit value.

Then, by sending, to the advertisement distribution device 30F, an advertisement request together with the price rank associated with the predicted eCPM expected value, the advertisement distribution management device 200 allows the advertisement distribution device 30F to distribute the advertising content of the eCPM that is associated with the price rank. In this way, it is assumed that, by allowing the advertisement distribution device 30F included in another vendor to distribute the advertising content on the basis of the price rank, the advertisement distribution management device 200 improves the profit of the administrator X.

Here, there may be a case in which the advertisement distribution device 30F passes back the advertisement request accepted from the advertisement distribution management device 200. For example, if the advertisement distribution management device 200 intensively and continuously sends advertisement requests for distributing the advertising content at the “Rank 3” that is associated with the “Zone 3” in a predetermined time period (for example, one hour between 12:00 and 13:00), there may be a case in which, from among the advertisement inventories in the advertisement distribution device 30F, an amount of the advertising content associated with the “Rank 3” is rapidly decreased or exhausted. At this time, the advertisement distribution device 30F passes back the accepted advertisement request to the advertisement distribution management device 200. In such a case, there may also be a case in which higher profit is expected when the advertisement distribution management device 200 also allocates the number of advertisement requests to the Zones other than the “Zone 3” and distributes the advertising content at the price rank that is associated with the allocated Zone.

Here, the advertisement distribution management device 200 determines the number of allocations by taking into consideration the number of advertisement requests to be allocated to each Zone that leads to higher profit. The advertisement distribution management device 200 allows the advertisement distribution device 30G that is the device owned by the administrator X to perform advertisement distribution with respect to the advertisement request that was passed back from the advertisement distribution device 30F. However, if the number of such passbacks is increased, there may be a case in which the advertisement distribution device 30G is also not able to distribute the advertising content depending on the processing load and, consequently, the profit is not possibly maximized. Thus, by taking into account this state, the advertisement distribution management device 200 determines the number of allocations in which higher profit can be expected with respect to the administrator X.

Specifically, the advertisement distribution management device 200 acquires, for each number of advertisement requests that are sent to the advertisement distribution device 30F per unit time such that the advertising content is distributed at a predetermined price rank, the average eCPM of the advertising content distributed by the advertisement distribution device 30F in accordance with the subject advertisement requests. The advertisement distribution management device 200 acquires such average eCPM for each price rank. Then, the advertisement distribution management device 200 determines, for each Zone on the basis of the acquired average eCPM for each price rank, the number of allocations that is the number of advertisement requests requested at the price rank associated with each Zone. Then, when the advertisement distribution management device 200 accepts an advertisement request from the terminal device 10, the advertisement distribution management device 200 sends the advertisement request to the advertisement distribution device 30F on the basis of both the eCPM expected value of the subject advertisement request and the number of allocations for each price rank, thereby allowing the advertisement distribution device 30F to distribute the advertising content. Furthermore, the advertisement distribution management device 200 allows the advertisement distribution device 30G to perform the advertisement distribution in accordance with the advertisement request that is passed back from the advertisement distribution device 30F.

The process performed by the advertisement distribution management device 200 configured in this way will be described with reference to FIG. 6A. First, the advertisement distribution management device 200 predicts a total of the number of advertisement requests to be accepted from one or more of the terminal devices 10 in a predetermined time period (Step S21). For example, it is assumed that the advertisement distribution management device 200 predicts “300” as the number of advertisement requests at the time from 12:00 to 13:00 (between 12:00 and 13:00) on Dec. 1, 2014. Here, the advertisement distribution management device 200 allocates the number of advertisement requests of “300”, which are the prediction result, to the Zones 1 to 5. At this time, the advertisement distribution management device 200 determines the number of allocations to be allocated to each Zone from among the number of predicted advertisement requests of “300” such that the profit obtained from the advertisement distribution device 30F is improved (Step S22).

In the following, the determination process performed at Step S22 will be described with reference to FIG. 6C. FIG. 6C is a schematic diagram illustrating an example of information stored in the storing unit in the advertisement distribution management device 200. FIG. 6C indicates an example of the average eCPM with respect to each of the number of advertisement requests per unit time (one hour in the example illustrated in FIG. 6C) in each Zone.

The average eCPM with respect to the number of advertisement requests per unit time is the average eCPM that is calculated by using the eCPM on the basis of the distribution track record of each of the pieces of the advertising content. In the example illustrated in FIG. 6C, for the number of advertisement requests “50” per unit time, the average eCPM of the advertising content distributed at the “Rank 1” associated with the “Zone 1” is “0.03”. Namely, this indicates that the average eCPM of each of the pieces of the advertising content distributed when the advertisement distribution device 30F accepts 50 advertisement requests associated with the “Rank 1” in one hour is “0.03”.

The “passback rate” indicates the rate of the number of passbacks for each price rank with respect to the number of advertisement requests sent by the advertisement distribution management device 200 at each price rank per unit time. For example, in FIG. 6C, the passback rate with respect to the number of advertisement requests of “50” in the Zone 3 per unit time is “0%”. Namely, if the advertisement distribution management device 200 sends 50 advertisement requests at the “Rank 3” that is associated with the “Zone 3” to the advertisement distribution device 30F in one hour, the probability of the passback to the advertisement distribution device 30F is “0%”.

Then, in FIG. 6C, when focusing on the number of advertisement requests of “50” per unit time, the average eCPM of the Zone 5 is “0.45”, which is the highest. Namely, in a case of processing the number of advertisement requests of “50” in one hour, the highest advertisement expenses can be expected to obtain when the advertising content is distributed at the “Rank 5” that is associated with the “Zone 5”. Then, when focusing on the number of advertisement requests of “100” per unit time, the average eCPM in the “Zone 5” is “0.36”, which is the highest. Namely, in a case of processing the number of advertisement requests of “100” in one hour, the highest advertisement expenses can be expected to obtain when the advertising content is distributed at the “Rank 5” that is associated with the “Zone 5”. However, if the advertisement requests are concentrated to the “Rank 5” associated with the “Zone 5” in this way, for example, because the advertising content corresponding to the “Rank 5” is exhausted, the advertisement distribution device 30F is not able to perform the advertisement distribution and thus passes back 52 advertisement requests.

For example, as illustrated in FIG. 6C, in the “Zone 5”, because the number of advertisement requests per unit time is increased from “50” to “100”, the passback rate is rapidly increased to “52%”. It is assumed that the advertising content that can be associated with the “Rank 5”, i.e., the advertising content that includes therein the eCPM of “0.35 to 0.45”, is extremely high advertising content and tends to be exhausted because the advertising content is likely to be targeted for the distribution.

The state of the passback rate of “52%” indicates that almost half of the number of advertisement requests are passed back, which does not consequently lead to improvement of the profit. If a passback is performed, for example, profit is more likely to be expected when the amount corresponding to the passback is dispersed to a lower price rank. Based on this, the advertisement distribution management device 200 determines the number of allocations to be allocated to each Zone, i.e., the amount of predicted advertising content, such that the profit is improved.

For example, if the number of predicted advertisement requests of “50” is allocated to the Zone, “50” is preferably allocated to the “Zone 5” in which the average eCPM is the highest and the passback rate is “0%”. Furthermore, if the number of predicted advertisement requests of “100” is allocated to each Zone, in the “Zone 5”, by taking into account the passback rate is increased to “52%” when the number of advertisement requests is “100”, it is preferable to allocate “50” to each of the “Zone 4” and the “Zone 5”.

Furthermore, as described above, when the number of predicted advertisement requests of “300” is allocated to each Zone, if the number of predicted advertisement requests is “100”, the advertisement request is preferably performed at the “Rank 5” with the highest average eCPM of “0.36”. However, because a half of 100 advertisement requests are passed back due to the passback rate of “52%”, regarding “100” out of the number of predicted advertisement requests of “300”, there is a high possibility that the profit is high when the advertising content is distributed at the “Rank 4” with the second highest average eCPM. Thus, it is preferable for the advertisement distribution management device 200 to allocate, for example, the “Zone 1:50”, the “Zone 2:50”, the “Zone 3:50”, the “Zone 4:100”, and the “Zone 5:50”. Namely, in the example illustrated in FIG. 6C, the advertisement distribution management device 200 determines that the number of allocations to be allocated to each of the “Zone 1” to the “Zone 5” from among the number of predicted advertisement requests of “300” as the “Zone 1:50”, the “Zone 2:50”, the “Zone 3:50”, the “Zone 4:100”, and the “Zone 5:50”. Furthermore, the number of allocations indicated here is an example and the number of advertisement requests other than the number of allocations may also be allocated to each of the Zones.

A description will be given here by referring back to FIG. 6A and the distribution process of the advertising content performed by the advertisement distribution management device 200 will be described. First, the terminal device 10 sends a page request that requests for the web page W10 to the web server 20 in accordance with the operation of the user U10 (Step S23). The web server 20 sends the web page W10 to the terminal device 10 in accordance with the page request from the terminal device 10 (Step S24).

When the terminal device 10 receives the web page W10 from the web server 20, the terminal device 10 sends an advertisement request to the advertisement distribution management device 200 (Step S25). For example, as illustrated in FIG. 6A, because the advertising space F10 is set on the web page W10, the terminal device 10 sends, to the advertisement distribution management device 200, the advertisement request that is a request for distributing the advertising content to be displayed on the advertising space F10.

Every time the advertisement distribution management device 200 accepts an advertisement request from the terminal device 10, the advertisement distribution management device 200 predicts the eCPM expected value that will be obtained when the advertising content is distributed by the advertisement distribution device 30G in accordance with the accepted advertisement request (Step S26).

Then, the advertisement distribution management device 200 sends the advertisement request on the basis of the predicted eCPM expected value and the determined number of allocations (Step S27). In a case of the example described above, the advertisement distribution management device 200 sends the advertisement requests that are accepted during the time period from 12:00 to 13:00 (between 12:00 and 13:00) on Dec. 1, 2014 such that the number of advertisement requests to be sent at a price rank associated with each of the Zones will be “Zone 1:50”, “Zone 2:50”, “Zone 3:50”, “Zone 4:100”, and “Zone 5:50”.

For example, it is assumed that the advertisement distribution management device 200 predicts that the eCPM expected value of the advertisement request accepted from the terminal device 10 is “0.45”. In the example illustrated in FIG. 6B, because the eCPM expected value “0.45” is included in the “Zone 5”, the advertisement distribution management device 200 sends the advertisement request to the advertisement distribution device 30F indicating that the advertising content is distributed at the “Rank 5” that is associated with the “Zone 5”. Then, in this time zone, when the number of advertisement request reaches 50 at the “Rank 5”, the advertisement requests at the “Rank 5” and the subsequent rank are set to the advertisement requests at the “Rank 4” by reducing the rank by one. Furthermore, this kind of process is performed on the advertisement requests at each price rank.

In this way, by sending an advertisement request at a price rank associated with the Zone that includes therein the eCPM expected value of the accepted advertisement request, the advertisement distribution management device 200 allows the advertising content associated with the subject rank to be distributed (Step S28). In the example illustrated in FIG. 6A, the advertisement distribution management device 200 accepts the advertising content distributed from the advertisement distribution device 30F and distributes the accepted advertising content to the terminal device 10 (Step S29).

Furthermore, if the advertisement request is passed back to the advertisement distribution device 30F, every time the advertisement distribution management device 200 accepts the passback, the advertisement distribution management device 200 allows the advertisement distribution device 30G to distribute the advertising content in accordance with the passback.

In this way, the advertisement distribution management device 200 predicts the number of advertisement requests that is accepted from the terminal device 10 in a predetermined time period. Then, the advertisement distribution management device 200 determines, on the basis of the average eCPM associated with each of the number of advertisement requests per unit time in each Zone, the number of allocations to be allocated to each of the Zones from among the number of predicted advertisement requests. Furthermore, when the advertisement distribution management device 200 actually accepts an advertisement request from the terminal device 10, the advertisement distribution management device 200 allows the advertisement distribution device 30F to distribute the advertising content by sending the advertisement requests at the price ranks that are associated with each of the Zones when the advertising content with respect to the accepted advertisement request is distributed by the advertisement distribution device 30G on the basis of the eCPM expected value and the determined number of allocations. Consequently, because the advertisement distribution management device 200 can improve the profit obtained from the distribution of the advertising content performed by the advertisement distribution device 30F, the advertisement distribution management device 200 can improve the profit of the administrator X of the advertisement distribution management device 200.

2. Configuration of an Advertisement Distribution Management Device

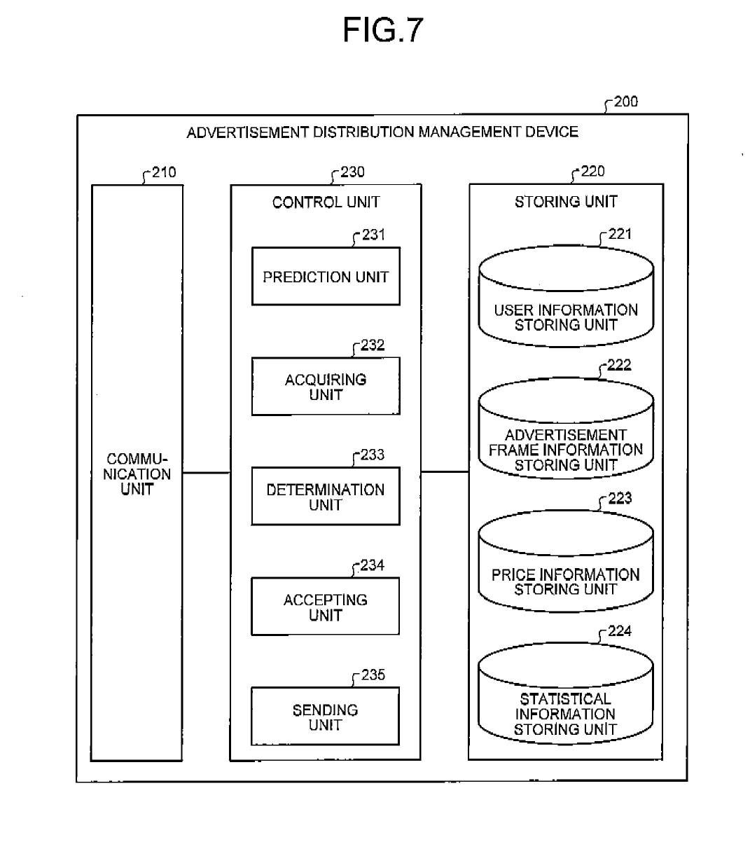

In the following, the advertisement distribution management device 200 according to the second embodiment will be described with reference to FIG. 7. FIG. 7 is a schematic diagram illustrating a configuration example of the advertisement distribution management device 200 according to the second embodiment. As illustrated in FIG. 7, the advertisement distribution management device 200 includes a communication unit 210, a storing unit 220, and a control unit 230.

The communication unit 210 is implemented by, for example, a NIC or the like. Then, the communication unit 210 is connected to the communication network in a wired or wireless manner.

The storing unit 220 is implemented by, for example, a semiconductor memory device, such as a RAM, a flash memory, and the like, or a storage device, such as a hard disk, an optical disk, and the like. As illustrated in FIG. 7, the storing unit 220 includes a user information storing unit 221, an advertising space information storing unit 222, a price information storing unit 223, and a statistical information storing unit 224.

About the User Information Storing Unit 221

In the user information storing unit 221, attribute information of a user ID, such as the age, the sex, the location, preferences, or the like of the user U10 is stored.

About the Advertising Space Information Storing Unit 222

In the advertising space information storing unit 222, for the advertising space ID, information, such as the type of the advertising space F10, the size, the position of a page, the click frequency, the display frequency, the average display time, or the like are stored in an associated manner.

About the Price Information Storing Unit 223

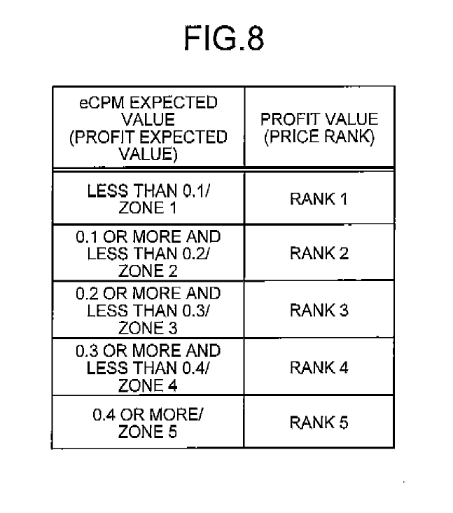

In the price information storing unit 223, a price information table is stored. FIG. 8 is a schematic diagram illustrating an example of a price information table stored in the price information storing unit 223. The price information table illustrated in FIG. 8 is information in which profit expected values are associated with price ranks and, in accordance with the profit expected values, the price ranks are associated in stages starting from a first price rank “Rank 1” to a fifth price rank “Rank 5”. Furthermore, in the second embodiment, it is assumed that the profit expected value is the eCPM (eCPM expected value) that is expected when advertising content with respect to an advertisement request received from the terminal device 10 is distributed by the advertisement distribution device 30G. Then, on the basis of such an eCPM expected value, the price information table illustrated in FIG. 8 is set.

Here, a method of obtaining the price information table will be described. The price information table may also previously be set by the advertisement distribution management device 200 or may also be acquired from another device. The price rank is indicated as, for example, a profit value. Such a profit value is set on the basis of the eCPM expected value that is the profit expected value. Then, the price rank is preferably set in the price information table such that the profit that can be obtained by the administrator X from the advertisement distribution device 30F becomes the profit that is equal to or greater than the profit expected value obtained by the advertisement distribution device 30G in its own company. Based on this, for example, the profit values illustrated in FIG. 6B are set as the price ranks. Specifically, as these profit values, the average value of the eCPM expected values for each range (Zone) of the eCPM expected value is set as the profit value of each of the price ranks. Furthermore, FIG. 6B schematically represents the price information table illustrated in FIG. 8 and indicates the relationship example between the profit expected values and the price ranks.

About the Statistical Information Storing Unit 224

The statistical information storing unit 224 stores therein various kinds of statistical data. Here, the statistical data related to the advertisement distribution device 30G is described as an example. The statistical information storing unit 224 stores therein, for each number of advertisement requests sent per unit time such that the advertising content is distributed at the price rank that is set on the basis of the eCPM expected value obtained when advertising content is distributed by the advertisement distribution device 30G, the average eCPM of the advertising content distributed by the advertisement distribution device 30F in accordance with the subject advertisement requests.

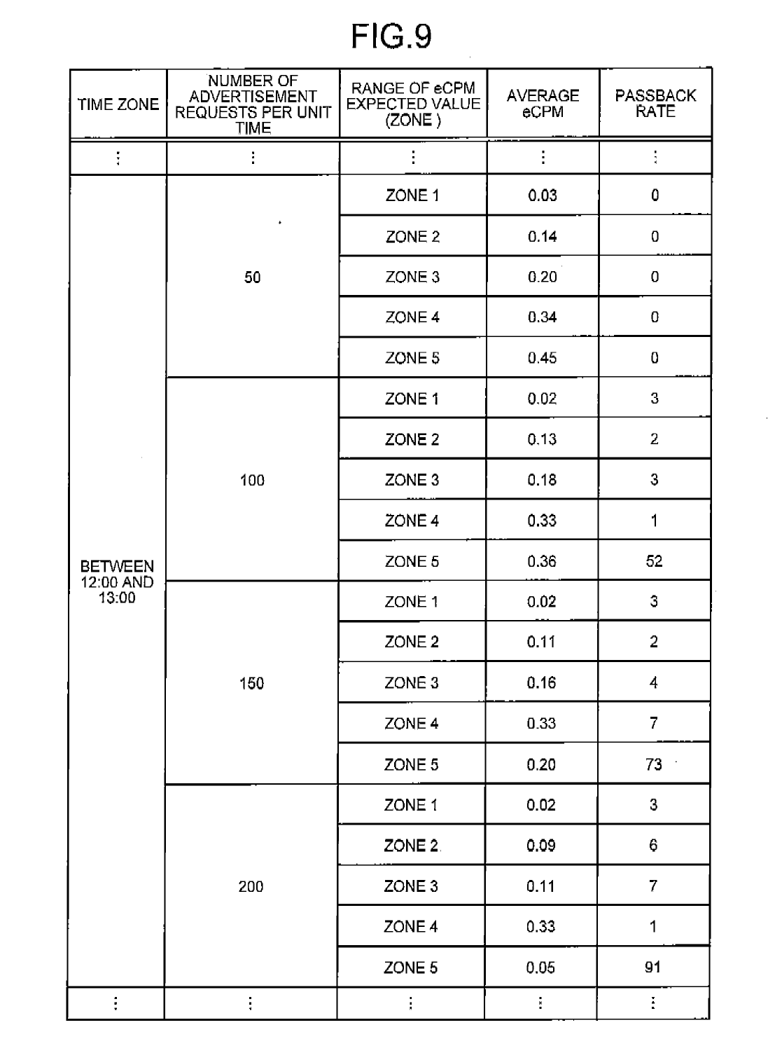

Here, FIG. 9 is a schematic diagram illustrating an example of the statistical information storing unit 224 according to the second embodiment. In the example illustrated in FIG. 9, the statistical information storing unit 224 includes the items, such as the “time zone”, the “number of advertisement requests per unit time”, the “range of an eCPM expected value”, the “average eCPM”, and the “passback rate”.

The “time zone” indicates each of the time zones once every hour. In FIG. 9, the time between 12:00 and 13:00 is indicated; however, actually, the statistical information storing unit 224 includes the data on 24 time zones indicating between 0:00 and 23:00. Furthermore, as the “number of advertisement requests per unit time”, values, such as 50, 100, 150, 200, and □, are indicated; however, this is an example and arbitrary values may be set. For example, the values at intervals of 10, such as 10, 20, and 30, may also be set. Furthermore, in the embodiment, it is assumed that the unit time is one hour; however, the unit time is not limited thereto. For example, the unit time may also be 30 minutes.

The “range of an eCPM expected value” is set on the basis of the eCPM expected when advertising content with respect to the advertisement request from the terminal device 10 is distributed by the advertisement distribution device 30G.

The “average eCPM” is the average eCPM calculated by using the eCPM on the basis of a distribution track record of each of the pieces of advertising content. In the example illustrated in FIG. 9, for the number of advertisement requests of “50” per unit time, the average eCPM of the advertising content distributed at the “Rank 1” that is associated with the “Zone 1” is “0.03”. Namely, this indicates that the average eCPM of each of the pieces of advertising content distributed when 50 advertisement requests associated with the “Rank 1” are accepted by the advertisement distribution device 30P in one hour is “0.03”.

The “passback rate” indicates the rate of the number of passbacks for each price rank with respect to the number of advertisement requests sent by the advertisement distribution management device 200 per unit time at each of the price rank. For example, in FIG. 9, the passback rate with respect to the number of advertisement requests of “50” in the Zone 3 per unit time is “0%”. Namely, the probability of passback to the advertisement distribution device 30F when the advertisement distribution management device 200 sends 50 advertisement requests to the advertisement distribution device 30F at the “Rank 3” associated with the “Zone 3” in one hour is “0%”.

Namely, FIG. 9 indicates that, for example, in a case in which 100 advertisement requests are sent to the advertisement distribution device 30F in one hour between 12:00 and 13:00 at the “Rank 1” that is associated with the “Zone 1”, the average eCPM of the advertising content that corresponds to the “Rank 1” and that is distributed by the advertisement distribution device 30F is “0.02”. Furthermore, FIG. 9 indicates that, for example, in a case in which the advertisement distribution device 30F accepts 100 advertisement requests at the “Rank 1” that is associated with the “Zone 1” in a time between 12:00 and 13:00, three advertisement requests tends to be passed back. Furthermore, instead of the “range of an eCPM expected value”, the statistical information storing unit 224 may also store therein the “price rank”.

About the Control Unit 230

The control unit 230 is implemented by, for example, a CPU, an MPU, or the like, executing various kinds of programs (corresponding to an example of advertisement distribution management program) stored in a storage device in the advertisement distribution management device 200, using a RAM as a work area. Furthermore, the control unit 230 is implemented by, for example, an integrated circuit, such as an ASIC, an FPGA, or the like.

As illustrated in FIG. 7, the control unit 230 includes a prediction unit 231, an acquiring unit 232, a determination unit 233, an accepting unit 234, and a sending unit 235 and implements or executes the function or the operation of the information processing described below. Furthermore, the internal configuration of the control unit 230 is not limited to the configuration illustrated in FIG. 7, and may also be another configuration as long as the configuration in which the information processing, which will be described later, is performed. Furthermore, the connection relation among the processing units included in the control unit 230 is not limited to the connection relation illustrated in FIG. 7 and another connection relation may also be used.

About the Prediction Unit 231

The prediction unit 231 predicts the number of advertisement requests accepted from the terminal device 10 within a predetermined time period. Specifically, the prediction unit 231 predicts, on the basis of the acceptance history accumulated up to this time, the number of advertisement requests accepted from the terminal device 10 within the predetermined time period. For example, if the predetermined time period is the “time between 12:00 and 13:00 on Dec. 1, 2014”, the prediction unit 231 predicts, from the acceptance history, the number of advertisement requests accepted from the terminal device 10 at a predetermined timing in this time zone. Any timing may also be possible for the timing at which the prediction unit 231 performs the prediction as long as the timing is before the predetermined time period that is targeted for the prediction. Then, the prediction unit 231 outputs the predicted number of advertisement requests to the acquiring unit 232.

About the Acquiring Unit 232

The acquiring unit 232 acquires data from the statistical information storing unit 224. Specifically, when the acquiring unit 232 accepts the number of predicted advertisement requests from the prediction unit 231, the acquiring unit 232 acquires, for each price rank and for each number of advertisement requests sent per unit time such that advertising content is distributed at a price rank that is set on the basis of the profit expected value obtained when the advertising content is distributed by another advertisement distribution device (for example, the advertisement distribution device 30G) other than the advertisement distribution device 30F, a profit expected value of the advertising content distributed by the advertisement distribution device 30F in accordance with an advertisement request. Furthermore, the acquiring unit 232 acquires the passback rate of the advertisement distribution device 30F. Furthermore, the acquiring unit 232 acquires, on the basis of the number of predicted advertisement requests accepted from the prediction unit 231, the average eCPM or the passback rate as the profit expected value.

For example, if it is predicted that the number of advertisement requests accepted by the prediction unit 231 from the terminal device 10 at the “time between 12:00 and 13:00 on Dec. 1, 2014” is “300”, the acquiring unit 232 allocates the number of predicted requests of “300” to each of the Zones 1 to 5 by using arbitrary values and then acquires the average eCPM and the passback rate of the Zones 1 to 5 associated with both the allocated values and the “time between 12:00 and 13:00 on Dec. 1, 2014”.

By using various patterns as combinations of arbitrary number of allocations, the acquiring unit 232 acquires the average eCPM and the passback rate of the “Zone 1” to the “Zone 5” associated with the subject patterns. As will be described later, the advertisement distribution management device 200 determines as the number of allocations from among these patterns, the pattern in which the total of the profit expected values obtained from the advertising content distributed by the price ranks associated with the “Zone 1” to the “Zone 5” becomes the maximum.

About the Determination Unit 233

The determination unit 233 determines, on the basis of the average eCPM and the passback rate acquired by the acquiring unit 232, the number of allocations of the advertisement requests to be allocated to the “Zone 1” to the “Zone 5”. Specifically, by using Expressions (4) and (5) below, the advertisement distribution management device 200 determines the number of allocations in which the total of a profit expected value obtained when the advertisement distribution device 30G distributes advertising content at each of the price ranks that are associated with the “Zone 1” to the “Zone 5” in a predetermined time zone and a profit expected value obtained when the advertisement distribution device 30G distributes advertising content in accordance with the advertisement request that is passed back from the advertisement distribution device 30F becomes the maximum.

Σ_{z}{(R(z,t)×P(z,t,r)}≦R(t) (4)

Σ_{z}[{1−P(z,t,r)}×R(z,t)×E(z,t,r)]+[Σ_{z}{R(z,t)×P(z,t,r)}]×F(t,r) (5)

Here, in Expression (4), the symbol “z” is information for identifying the “Zone 1” to the “Zone 5”. The symbol “t” is information for identifying the time zone. Namely, the symbol R(z, t) indicates the number of allocations that is the predicted advertisement requests allocated to the Zone “z” in the time zone “t”.

Furthermore, the symbol “r” indicates the number of advertisement requests on the basis of the distribution track record in the time zone “t”. For example, the symbol “r” is associated with the “number of advertisement requests per unit time” illustrated in FIG. 9. Namely, the symbol P(z, t, r) indicates a passback rate obtained when the number of advertisement requests “r” is allocated to the Zone “z” in the time zone “t”. Namely, R(z, t)□P(z, t, r) indicates the number of passbacks caused by the number of advertisement requests “r” being allocated to the Zone “z” in the time zone “t”.

Furthermore, the symbol R(t) indicates the upper limit of the number of advertisement requests that can be processed by the advertisement distribution device 30G in the time zone “t”. Namely, Expression (4) indicates the constraint condition for constraining the sum total of the number of passbacks with respect to the advertisement requests at the price rank associated with each of the “Zone 1” to the “Zone 5” in the time zone “t” such that the sum total does not exceed the upper limit of the number of advertisement requests that can be processed by the advertisement distribution device 30G in the time zone “t”.

In the following, Expression (5) will be described. The symbol “1−P(z, t, r)” indicates the rate of the number of advertisement requests in the Zone “z” processed by the advertisement distribution device 30F in the time zone “t”. Furthermore, the symbol E(z, t, r) indicates the average eCPM of the advertising content distributed by the advertisement distribution device 30F in accordance with an advertisement request in the Zone “z” in the time zone “t”. Namely, because {1−P(z, t, r)}×R(z, t)×E(z, t, r) corresponds to the sum total of the eCPM of the advertising content distributed by the advertisement distribution device 30F in accordance with the “r” advertisement requests in the Zone “z” in the time zone “t”, the determination unit 233 calculates a value corresponding to the sum total of the eCPM in the “Zone 1” to the “Zone 5”.

Furthermore, the symbol F(t, r) indicates the average eCPM of the number of advertisement requests “r” distributed by the advertisement distribution device 30G in the time zone “t”. Then, by multiplying F(t, r) by the sum total of the number of passbacks with respect to the advertisement requests at the price rank associated with each of the “Zone 1” to the “Zone 5” in the time zone “t”, the determination unit 233 calculates a value corresponding to the sum total of the eCPM of the advertising content distributed by the advertisement distribution device 30G in the time zone “t”.

Because of the above, Expression (5) is the objective function indicating the total of the sum total of the eCPM of the advertising content distributed by the advertisement distribution device 30F at the price rank associated with each of the “Zone 1” to the “Zone 5” in the time zone “t” and the sum total of the eCPM of the advertising content distributed by the advertisement distribution device 30G in accordance with the passback in the time zone “t”. Thus, the determination unit 233 determines, under the constraint condition of Expression (4), Expression (5), i.e., R(z, t) in which the total of the sum total of all the eCPM of the advertising content distributed by the advertisement distribution device 30F at the price rank associated with each of the “Zone 1” to the “Zone 5” in the time zone “t” and the sum total of the eCPM of the advertising content distributed by the advertisement distribution device 30G in accordance with the passback becomes the maximum. Furthermore, the determination unit 233 may also store the calculated number of allocations R(z, t) in a predetermined storing unit (for example, a buffer).

About the Accepting Unit 234

The accepting unit 234 accepts an advertisement request from the terminal device 10. Then, the accepting unit 234 outputs the accepted advertisement request to the sending unit 235. In the advertisement request, a user ID or the like of the terminal device 10 is included.

About the Sending Unit 235

The sending unit 235 allows advertising content to the advertisement distribution device that is the transmission destination by sending the advertisement request accepted by the accepting unit 234 to the advertisement distribution device. Specifically, first, the sending unit 235 predicts an eCPM expected value obtained when the advertising content with respect to the advertisement request accepted by the accepting unit 234 is distributed by the advertisement distribution device 30G.

The sending unit 235 calculates, for example, a click through ratio (CTR) expected value and a cost per click (CPC) expected value and calculates an eCPM expected value by multiplying the CTR expected value by the CPC expected value.

The CTR expected value is an expected value of CTR with respect to an advertisement request. The sending unit 235 calculates a CTR expected value by using, for example, a support vector machine (SVM) and the sigmoid fitting, using a click to the advertising content of an advertising space as a dependent variable, and using attribute information of the user U10 or the information in the advertising space as an independent variable. Furthermore, the sending unit 235 can also calculates a CTR expected value by a logistic regression analysis.

Furthermore, the CPC expected value is an expected value of CPC with respect to the advertisement request. The sending unit 235 calculates a CPC expected value by using, for example, a multiple regression analysis or a Poisson regression analysis, using a distribution unit price (for example, CPC or cost per action (CPA)) of the advertising content of a distribution candidate with respect to an advertisement request as a dependent variable, and using attribute information about the user U10 or the information about an advertising space as an independent variable.

Then, by sending the advertisement request to the advertisement distribution device on the basis of both the predicted eCPM expected value and the number of allocations determined by the determination unit 233, the sending unit 235 allows the advertisement distribution device at the transmission destination to distribute the advertising content. Specifically, the sending unit 235 sends the advertisement request to the advertisement distribution device 30F on the basis of the number of allocations R(z, t) associated with the time zone in which the advertisement request was accepted. Regarding the transmission of the advertisement request performed by the sending unit 235, the following process can be conceived.

Every time the sending unit 235 accepts an advertisement request, the sending unit 235 requests advertisement distribution at a price rank of the Zone associated with the eCPM expected value of the subject advertisement request. Here, if the number of allocations determined in each Zone is filled by the number of advertisement requests to be sent, the sending unit 235 sends the subsequent advertisement request for the filled Zone to, the Zone that is at the immediately lower level. For example, if the advertisement distribution management device 200 determines that the number of allocations to the Zone 3 is “300”, the advertisement distribution management device 200 sends the advertisement requests associated with the subsequent Zone 3 to the Zone 2 when the total number of the advertisement requests associated with the Zone 3 exceeds “300”. Then, the sending unit 235 performs the same process on each Zone.

3. Flow of the Advertisement Distribution Process

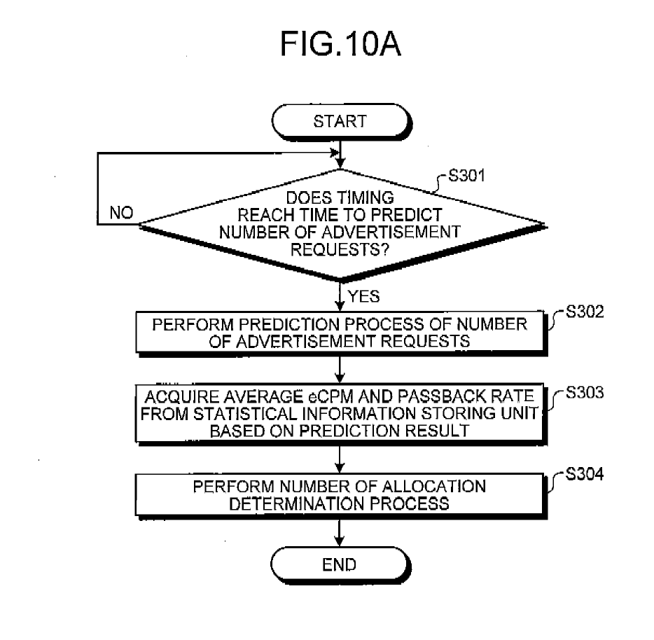

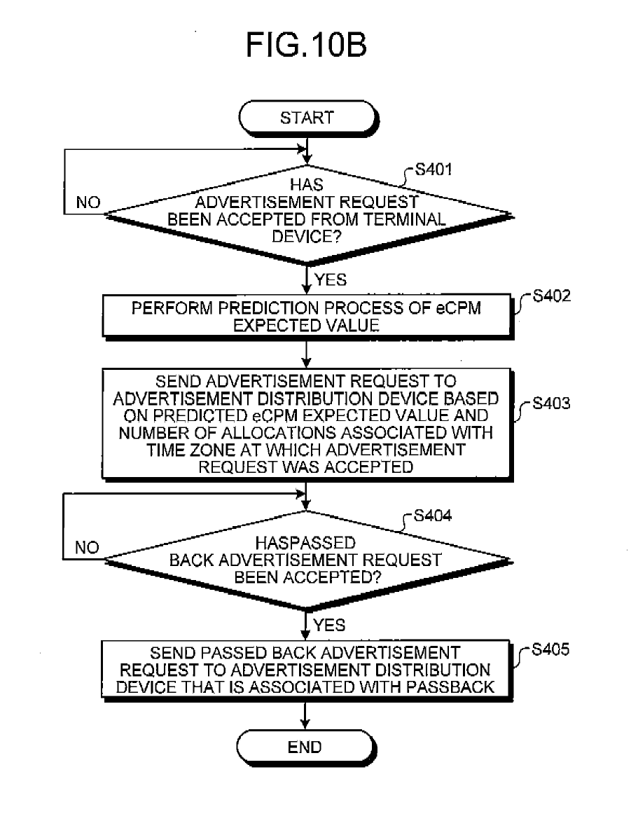

In the following, the flow of a process performed by the advertisement distribution system 2 according to the second embodiment will be described with reference to FIGS. 10A and 10B.

3-1. Flow of the Advertisement Distribution Process

First, the flow a process performed by the advertisement distribution management device 200 according to the second embodiment will be described with reference to FIG. 10A. FIG. 10A is a flowchart illustrating the flow of a number of allocations determination process performed by the advertisement distribution management device 200 according to the second embodiment.

As illustrated in FIG. 10A, the prediction unit 231 in the advertisement distribution management device 200 determines whether the timing reaches the time to predict the number of advertisement requests that are accepted from the terminal device 10 within a predetermined time period (Step S301). The prediction timing may also arbitrarily and previously be set with respect to the advertisement distribution management device 200 and set in combination of, for example, the date, a day of the week, the time, or the like. Then, if the prediction unit 231 determines that the timing is the prediction timing (Yes at Step S301), the prediction unit 231 starts a prediction process and sends a prediction result to the acquiring unit 232 (Step S302). In contrast, if the prediction unit 231 determines that the timing is not the prediction timing (No at Step S301), the prediction unit 231 waits until the timing reaches the prediction timing.

The acquiring unit 232 acquires data from the statistical information storing unit 224 (Step S303). Specifically, if the acquiring unit 232 accepts the number of predicted advertisement requests from the prediction unit 231, the acquiring unit 232 acquires, for each price rank and for each of the number of advertisement requests sent per unit time such that advertising content is distributed at a price rank that is set on the basis of the profit expected value obtained when the advertising content is distributed by another advertisement distribution device (for example, the advertisement distribution device 30G in its own company) other than the advertisement distribution device 30F, the profit expected value of the advertising content that is distributed by the advertisement distribution device 30F in accordance with the advertisement request. Furthermore, the acquiring unit 232 acquires the passback rate of the advertisement distribution device 30F. Furthermore, the acquiring unit 232 acquires, on the basis of the number of predicted advertisement requests accepted from the prediction unit 231, the average eCPM and the passback rate as the profit expected value. Then, the acquiring unit 232 outputs the acquired the average eCPM and the passback rate to the determination unit 233.

Then, the determination unit 233 determines, by using the data received from the acquiring unit 232, the number of allocations of the number of requests to be allocated for each range (Zone) of the profit expected value (Step S304). When the examples illustrated FIGS. 6A to 6C will be described, by calculating using Expression (5) under the constraint condition indicated by Expression (4), the determination unit 233 determines the number of allocations in which the total of the profit expected value obtained when the advertisement distribution device 30F distributes, in a predetermined time zone, advertising content at each of the price ranks that are associated with the “Zone 1” to the “Zone 5” and the profit expected value obtained when the advertisement distribution device 30G distributes advertising content in accordance with an advertisement request that is passed back from the advertisement distribution device 30F becomes the maximum.

3-2. Flow of the Distribution Process

In the following, the flow of the process performed by the advertisement distribution management device 200 according to the second embodiment will be described with reference to FIG. 10B. FIG. 10B is a flowchart illustrating the flow of a distribution process performed by the advertisement distribution management device 200 according to the second embodiment.

As illustrated in FIG. 10B, the accepting unit 234 determines whether an advertisement request has been accepted from the terminal device 10 (Step S401). If the accepting unit 234 determines that advertisement request has been accepted (Yes at Step S401), the accepting unit 234 outputs the advertisement request to the sending unit 235. In the advertisement request, for example, attribute information or the like, such as a user ID, an advertising space ID, and advertising space, is included. In contrast, if the accepting unit 234 determines that advertisement request has not been accepted (No at Step S401), the accepting unit 234 waits until that the advertisement request is accepted.

Then, the sending unit 235 predicts an eCPM expected value obtained when the advertising content with respect to the advertisement requests accepted by the accepting unit 234 is distributed by the own company's advertisement distribution device (the advertisement distribution device 30G) (Step S402). Then, by sending the advertisement request to the advertisement distribution device on the basis of the predicted eCPM expected value and on the basis of the number of allocations associated with the time zone in which the advertisement requests are received from among the number of allocations determined by the determination unit 233, the sending unit 235 allows the advertisement distribution device at the transmission destination to distribute the advertising content (Step 3403). For example, the sending unit 235 sends the advertisement requests to the advertisement distribution device 30F.

Furthermore, the sending unit 235 determines whether a passed back advertisement request has been accepted (Step S404). If the sending unit 235 determines that a passed back advertisement request has been accepted (Yes at Step S404), by sending the passed back advertisement request to the advertisement distribution device (the advertisement distribution device 30G) that is associated with the passback, the sending unit 235 allows the advertising content to be distributed (Step S405). In contrast, if the sending unit 235 determines that a passed back advertisement request has not been accepted (No at Step S404), the sending unit 235 waits until the passed back advertisement request is accepted. Furthermore, the processes performed at Steps S403 and S404 may also simultaneously be performed.

4. Modification

The advertisement distribution management device 200 according to the second embodiment may also be performed with various kinds of embodiments other than the embodiments described above. Therefore, another embodiment will be described below.

4-1. Control of an Advertisement Request (1)

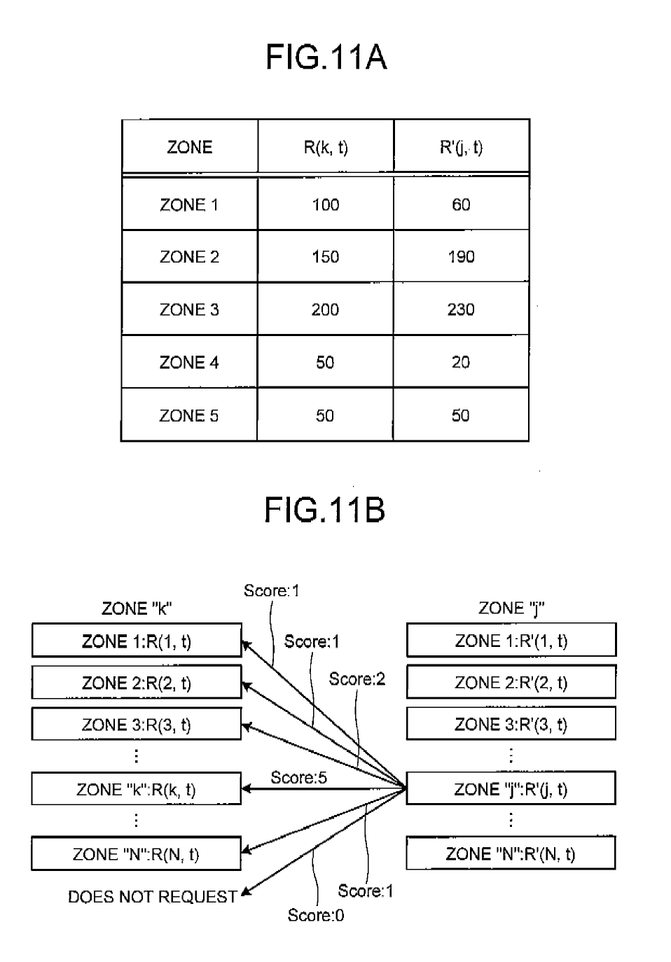

The second embodiment indicates an example in which the determination unit 233 in the advertisement distribution management device 200 determines the number of allocations of advertisement requests to be allocated to the “Zone 1” to the “Zone 5” in the time zone “t”. However, in the advertisement distribution management device 200, the acquiring unit 232 may also acquire the number of advertisement requests for each price rank associated with the profit expected value that is obtained when the advertisement distribution device 30G distributes advertising content in accordance with the advertisement requests that were accepted in the past and the sending unit 235 may also set a price rank to a new advertisement request on the basis of the number of advertisement requests for each price rank acquired by the acquiring unit 232, on the basis of the number of allocations for each price rank determined by the determination unit 233, and on the basis of the price rank associated with the new advertisement request. This point will be described with reference to FIGS. 11A and 11B. FIG. 11A is a schematic diagram illustrating the relationship between the number of advertisement requests and the number of allocations based on a distribution track record in each Zone. Furthermore, FIG. 11B is a schematic diagram illustrating advertisement request transmission destinations.

For example, it is assumed that the determination unit 233 determines, in the determination process described above, that the number of allocations of the advertisement requests to be allocated to the “Zone 1” to the “Zone 5” in the time zone “t” is R(k, t). The symbol “k” is identification information for identifying the Zone in which the number of allocations has been determined by the determination unit 233. Furthermore, it is assumed that the number of advertisement requests actually accepted in the past time zone “t” is R′(j, t). The symbol “j” indicates the Zone that is associated with the past track record. For example, the symbol R′(j, t) indicates the number of advertisement requests in the Zone “j” based on the eCPM expected value from among the advertisement requests that were actually accepted in the past in the time zone “t”. This point will be more specifically described.

As illustrated in FIG. 11A, it is assumed that the determination unit 233 determines that the number of allocations in the time zone “t” is “Zone 1:100”, “Zone 2:150”, “Zone 3:200”, “Zone 4:50”, and “Zone 5:50”. Each of the Zones in which the number of allocations has been determined by the determination unit 233 in this way is the Zone “k”. Furthermore, it is assumed that, in the past time zone “t”, when predicting the eCPM expected value that is obtained when advertising content with respect to the accepted advertisement request is distributed by the advertisement distribution device 30G, the number of advertisement requests for each Zone is “Zone 1:60”, “Zone 2:190”, “Zone 3:230”, “Zone 4:20”, and “Zone 5:50”. Such Zones based on the eCPM expected value are referred to as the Zone “j”.

Here, the number of advertisement requests in the Zone “j”, i.e., “60”, “90”, “230”, “20”, and “50”, is not the number of advertisement requests that were actually at the price rank associated with each of the Zones. As described above, the number of advertisement requests is the counted number for each Zone on the basis of the eCPM expected value of the advertisement request accepted in the time zone “t”. Furthermore, the number of advertisement requests for each Zone obtained in this way is the result of the advertisement requests that were actually accepted and thus are the values of the past track records.

Furthermore, the symbol R(k, t) that is the number of allocations determined by the determination unit 233 is a predicted value and thus it is conceivable that there is a difference with R′(j, t) that is the value of the track record. Here, for example, when focusing on the “Zone 3”, R(k, t) is 200 and R′(j, t) is 230. Because the number of allocations determined by the determination unit 233 can further increase a profit expected value, the number of allocations with respect to the “Zone 3” is preferably be “200”. However, because the number of advertisement requests associated with the “Zone 3”, which is assumed to actually be accepted, is “230”, for example, it is conceivable that the remaining “30” is allocated to any one of the Zone “k”. At this time, a difference occurs in profit depending on the allocation of “30”. For example, a difference occurs in the profit between a case in which all the advertisement requests of “30” are allocated to the “Zone 1” and a case in which the advertisement requests of “10” are allocated to each of the “Zone 1”, the “Zone 2”, and the “Zone 3”. Furthermore, instead of the remaining “30” advertisement requests, it is conceivable that the number of advertisement requests of “230”, which is the value of the track record, are allocated to any one of the Zone “k”.

Namely, instead of associating, in the past time zone “t”, a newly accepted advertisement request with the Zone that is based on the eCPM expected value, the sending unit 235 sets the number of advertisement requests to be associated with one of the Zones such that the profit expected value is improved. Specifically, as illustrated in FIG. 11B, the sending unit 235 determines the number of advertisement requests, which are newly accepted and are in the Zone “j” based on a track record value, to be allocated to each Zone, such as the Zone “1” to the Zone “N”, from among the Zone “k” in which the number of allocations is set by the determination unit 233. Consequently, for example, for the track record value, the number to be associated with the Zone that is different from the “Zone 1” is determined in the determination process performed by the sending unit 235. For example, 60 advertisement requests in the Zone 1 are allocated, such as “Zone 1:0”, “Zone 2:20”, “Zone 3:0”, “Zone 4:10”, and “Zone 5:30”.

As described above, the sending unit 235 determines R′(j, t) in which a value such that the profit expected value becomes the maximum in the combination of X(j, k, t), assuming that the number set to the Zone “k” is X(j, k, t). In this case, the constraint condition is represented by Expressions (6) and (7).

ΣₖX(j,k,t)=R′(j,t) (j=1,2,3, . . . ,N+1) (6)

ΣⱼX(j,k,t)≦R(k,t) (k=1,2,3, . . . ,N+1) (7)

Then, under the constraint condition of Expressions (6) and (7), the sending unit 235 determines X(j, k, t) that becomes the maximum in Expression (8).

Σ{_{lg}X(j,k,t)·S(j,k,t)} (8)

Because the symbol S(j, k, t) is a score (coefficient) that is set based on the size of the eCPM expected value, Expression (8) is an objective function indicating that, for the number of advertisement requests accepted in the time zone “t”, the sum total of the profit obtained by allocating, to the Zone “k”, values that are the track record values for each Zone. Thus, the sending unit 235 determines X(j, k, t) that becomes the maximum in Expression (8).

Consequently, the advertisement distribution management device 200 can obtain an optimum transmission destination in which profit of an advertisement request becomes the maximum and obtain the number of advertisement requests sent to the transmission destination.

4-2. Control of an Advertisement Request (2)

In 4-1, an example has been described in which the sending unit 235 determines the number of advertisement requests to be allocated for each Zone based on a distribution track record such that profit is improved with respect to each of the Zones in which the number of allocations has been determined by the determination unit 233. However, this process may also be performed on each of the advertisement distribution devices.

Specifically, in the advertisement distribution management device 100 according to the first embodiment, the acquiring-unit 132 acquires the number of advertisement requests for each of the advertisement distribution devices that are determined by a predetermined condition as the transmission destination of the advertisement request that was accepted in the past. Then, on the basis of the number of advertisement requests for each advertisement distribution device acquired by the acquiring unit 132, the number of allocations for each advertisement distribution device determined by the determination unit 133, and transmission destination for a new advertisement request determined by the predetermined condition, the sending unit 135 determines an advertisement distribution device that becomes the transmission destination of the new advertisement request.

For example, for the advertisement request that was accepted in the time zone “t” in the past, as a predetermined condition, by using an attribute of a transmission user, an attribute of a web page, or the like, the advertisement distribution management device 100 determines that the number of advertisement requests associated with the advertisement distribution device 30A, the advertisement distribution device 30B, and the advertisement distribution device 30C are “50” for the advertisement distribution device 30A, “100” for the advertisement distribution device 30B, and “40” for the advertisement distribution device 30C, respectively. Such a track record value corresponds to R′(j, t).

Furthermore, it is assumed that the number of allocations, such as “30” for the advertisement distribution device 30A, “110” for the advertisement distribution device 30B and “50” for the advertisement distribution device 30C, is determined by the determination unit 133.

Here, when focusing on the advertisement distribution device 30A, if the sending unit 135 newly accepts an advertisement request, for the advertisement requests associated with the advertisement distribution device 30A, the sending unit 135 sends advertisement requests up to 30 requests to the advertisement distribution device 30A and determines the transmission destination of the subsequent advertisement requests associated with the advertisement distribution device 30A. For example, the sending unit 135 determines the number of the remaining advertisement requests and determines the advertisement distribution devices to be selected as the transmission destination. At this time, the sending unit 135 determines a combination in which the profit of each of the advertisement distribution devices is increased. At this time, the sending unit 135 performs calculation by using Expression (8) above under the constraint condition of Expressions (6) and (7).

Consequently, the advertisement distribution management device 100 can obtain an optimum transmission destination in which profit of an advertisement request becomes the maximum and obtain the number of advertisement requests sent to the transmission destination.

4-3. The Number of Allocations Determination Process

The advertisement distribution management device 100 according to the first embodiment may also be combined with the advertisement distribution management device 200 according to the second embodiment. In this case, when the advertisement distribution devices 30A to 30D according to the first embodiment are used as example, the advertisement distribution management device 200 determines the number of allocations of advertisement requests to be allocated to the “Zone 1” to the “Zone 5” of each of the advertisement distribution devices 30A to 30D. Furthermore, the advertisement distribution management device 200 stores therein, as the statistical information illustrated in FIG. 9, the statistical information for each Zone with respect to each of the advertisement distribution devices 30A to 30D.

5. Advantages

As described above, the advertisement distribution management device 200 according to the second embodiment includes the acquiring unit 232, the determination unit 233, and the sending unit 235. The acquiring unit 232 acquires, for each number of advertisement requests sent to the advertisement distribution device per unit time, a profit expected value of the advertising content that is distributed by the advertisement distribution device in accordance with the advertisement requests. The determination unit 233 determines, on the basis of the profit expected value acquired by the acquiring unit 232, the number of allocations of advertisement requests to be allocated to the advertisement distribution device. The sending unit 235 sends, on the basis of the number of allocations determined by the determination unit 233, a new advertisement request to the advertisement distribution device.

Consequently, because the advertisement distribution management device 200 according to the second embodiment can determine the number of advertisement requests allocated for each price rank that is provided for the advertisement distribution device such that the profit obtained from the advertising content distributed by the subject advertisement distribution device is improved, the advertisement distribution management device 200 can improve the profit of the administrator of the advertisement distribution management device 200.

Furthermore, the acquiring unit 232 according to the second embodiment acquires, for each price rank and for each number of advertisement requests sent to the advertisement distribution device per unit time such that the advertising content is distributed at the price rank that is set on the basis of the profit expected value obtained when the advertising content is distributed by another advertisement distribution device that is other than the advertisement distribution device, a profit expected value of the advertising content that is distributed by the advertisement distribution device in accordance with the advertisement requests and the determination unit 233 determines, on the basis of the profit expected value acquired by the acquiring unit 232 for each price rank, the number of allocations of advertisement requests to be allocated to the advertisement distribution device for each price rank.

Consequently, the advertisement distribution management device 200 according to the second embodiment can improve the profit of the administrator of the advertisement distribution management device 200.

Furthermore, the acquiring unit 232 according to the second embodiment acquires a rejection rate that is the rate at which advertisement request that requests to send advertising content at a price rank is rejected by the advertisement distribution device and the determination unit 233 determines, on the basis of the rejection rate acquired by the acquiring unit 232, the number of allocations of advertisement requests to be allocated to the advertisement distribution device for each price rank.

Consequently, the advertisement distribution management device 200 according to the second embodiment can accurately determine the number of allocations, for each price rank, that can improve the profit of the administrator of the advertisement distribution management device 200.

The determination unit 233 according to the second embodiment determines the number of allocations on the basis of a profit expected value for each price rank acquired by the acquiring unit 232 and on the basis of a profit expected value obtained when advertising content with respect to the advertisement request that is associated with the price rank rejected by the advertisement distribution device is distributed by another advertisement distribution device.

Consequently, the advertisement distribution management device 200 according to the second embodiment can accurately determine the number of allocations, for each price rank, that can improve the profit of the administrator of the advertisement distribution management device 200.

### Another Embodiment

The first and the second embodiment described above may also be performed with various kinds of embodiments other than the embodiments described above. Therefore, another embodiment will be described below.

1. Advertisement Request Transmission Process

In the second embodiment, an example has been described in which, every time the sending unit 235 accepts an advertisement request, the sending unit 235 requests advertisement distribution at the price rank associated with the eCPM expected value of the subject advertisement request and sends, for the Zone that is filled with the number of allocations determined by the determination unit 233, the subsequent advertisement requests that are associated with the subject Zone to the Zone at the level immediately lower than the subject Zone. Such a transmission process may also be performed by the sending unit 135 in the advertisement distribution management device 100 according to the first embodiment.

For example, every time the sending unit 135 accepts an advertisement request, the sending unit 135 determines, from a user attribute of a user who sent the advertisement request, an attribute of the web page W10, an attribute of the advertising space F10, or the like, an advertisement distribution device that becomes the transmission destination. Then, the sending unit 135 sends the advertisement requests to the determined advertisement distribution device. Here, if the number of allocations determined with respect to the advertisement distribution device is filled by the number of advertisement requests to be sent, the sending unit 135 send, for the subsequent advertisement requests with respect to the filled advertisement distribution device, the subsequent advertisement requests to the advertisement distribution device in which the average eCPM (for example, the average eCPM associated with each of the number of advertisement requests per unit time) is subsequently lower than that in the subject advertisement distribution device. Then, the sending unit 135 performs the same process on each of the advertisement distribution devices.

2. Variance Consideration

In the embodiment described above, an example has been described in which the advertisement distribution management device 100 determines the number of allocations of advertisement requests with respect to each of the advertisement distribution devices by using the average eCPM with respect to each of the number of advertisement requests per unit time in each of the advertisement distribution devices. Furthermore, an example has been described in which the advertisement distribution management device 200 determines the number of allocations of advertisement requests with respect to each of the Zones by using the average eCPM with respect to each of number of advertisement requests per unit time in each of the Zones. However, instead of using the average eCPM as the statistical data of eCPM, the advertisement distribution management devices 100 and 200 may also use, for example, dispersion of the eCPM.

For example, in the unit time, it is assumed that eCPM dispersion data on each of the pieces of advertising content distributed with respect to 50 advertisement requests can be acquired from each of the advertisement distribution devices. At this time, the advertisement distribution management device 100 may also use the eCPM with the greatest dispersion or may also use the eCPM with the smallest dispersion.

Furthermore, for example, it is assumed that, by sending 50 advertisement requests to the advertisement distribution device 30F for each Zone per unit time, the eCPM dispersion data on the advertising content with respect to the advertisement requests for each Zone can be acquired from the advertisement distribution device 30F. At this time, the advertisement distribution management device 200 may also use the eCPM with the greatest dispersion or may also use the eCPM with the smallest dispersion for each Zone.

Furthermore, if a variance is used in Expressions (2) and (5), a predetermined dispersion coefficient is multiplied by E(a, t, r) and E(z, t, r). For example, when the dispersion coefficient is represented by “□”, if the influence of the dispersion is desired to be increased, “□” is multiplied by E(a, t, r) and E(z, t, r). Furthermore, if the influence of the dispersion is desired to be decreased, “1/□” is multiplied by E(z, t, r) and E (a, t, r).

3. Operation of a Parameter Coefficient

As described above, Expressions (1) and (4) that are the constraint conditions and Expressions (2) and (5) that are the objective functions are structured by various parameters. For example, by using weighting factors with respect to these parameters, a predetermined parameter may also arbitrarily be increased and decreased. An example of this will be described.

In the embodiments described above, a description has been given in which, for the advertisement distribution device 30E and the advertisement distribution device 30G operated by the administrator X, because an upper limit of the number of advertisement requests that can be processed per unit time is present, the advertisement distribution management device 100 uses Expression (1) and the advertisement distribution management device 200 uses Expression (4) as the constraint condition for not exceeding the upper limit.

However, because the values calculated by using Expressions (1) and (4) are predicted values, the values do not always exceed the upper limit. Thus, the advertisement distribution management device 100 and the advertisement distribution management device 200 may also multiply the weighting factor that decreases F(t, r). Consequently, the advertisement distribution management device 100 can reduce the processing load due to a passed back request with respect to the advertisement distribution device 30E. Furthermore, the advertisement distribution management device 200 can reduce the processing load due to the passed back request with respect to the advertisement distribution device 30G.

4. Program

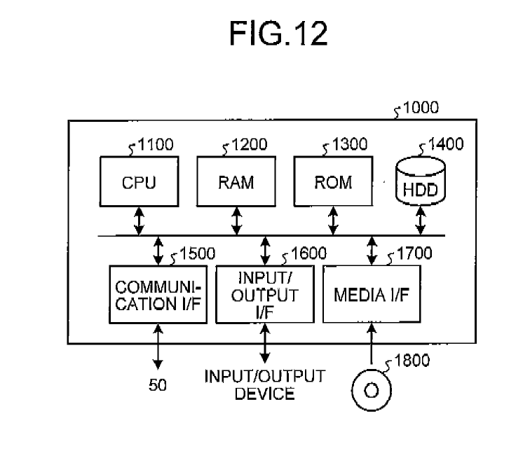

Furthermore, the advertisement distribution management device 100 according to the first embodiment and the advertisement distribution management device 200 according to the second embodiment are implemented by, for example, a computer 1000 having a configuration illustrated in FIG. 12. In the flowing, a description will be given by using the advertisement distribution management device 100 as an example. FIG. 12 is a block diagram illustrating the hardware configuration indicating an example of the computer 1000 that implements the function performed by the advertisement distribution management device 100. The computer 1000 includes a CPU 1100, a RAM 1200, a ROM 1300, an HDD 1400, a communication interface (I/F) 1500, an input/output interface (I/F) 1600, and a media interface (I/F) 1700.

The CPU 1100 operates on the basis of the program stored in the ROM 1300 or the HDD 1400 and performs control of each unit. The ROM 1300 stores therein a boot program that is executed by the CPU 1100 when the computer 1000 is started up, a program that depends on the hardware of the computer 1000, and the like.

The HDD 1400 stores therein a program executed by the CPU 1100, data that is used by the program, and the like. The communication interface 1500 receives data from other devices via a communication network 50 (corresponds to the communication network N illustrated in FIG. 2) and sends the data to the CPU 1100, and sends data created by the CPU 1100 to other devices via the communication network 50.

The CPU 1100 controls an output device, such as a display, a printer, or the like, and an input device, such as a keyboard, a mouse, or the like via the input/output interface 1600. The CPU 1100 acquires data from the input device via the input/output interface 1600. Furthermore, the CPU 1100 outputs the created data to the output device via the input/output interface 1600.

The media interface 1700 reads a program or data stored in a recording medium 1800 and provides the program or the data to the CPU 1100 via the RAM 1200. The CPU 1100 loads the program onto the RAM 1200 from the recording medium 1800 via the media interface 1700 and executes the loaded program. The recording medium 1800 is, for example, an optical recording medium, such as a digital versatile disc (DVD), a phase change rewritable disk (PD), or the like, a magnetic recording medium, such as a magneto-optical recording medium such as a magneto-optical disk (MO), or the like, a tape medium, a semiconductor memory, or the like.

For example, when the computer 1000 functions as the advertisement distribution management device 100 according to the first embodiment, the CPU 1100 in the computer 1000 executes the program loaded into the RAM 1200, thereby implementing the function performed by the control unit 130. Furthermore, the HDD 1400 stores therein the data in the statistical information storing unit 120. The CPU 1100 of the computer 1000 reads these programs from the recording medium 1800 and executes the programs. However, as another example, the CPU 1100 may also acquire these programs from another device via the communication network 50.

Furthermore, if the computer 1000 functions as the advertisement distribution management device 200 according to the second embodiment, the CPU 1100 in the computer 1000 implements the function performed by the control unit 230 by executing the program loaded in the RAM 1200.

5. Others

Of the processes described in the embodiment, the whole or a part of the processes that are mentioned as being automatically performed can also be manually performed, or the whole or a part of the processes that are mentioned as being manually performed can also be automatically performed using known methods. Furthermore, the flow of the processes, the specific names, and the information containing various kinds of data or parameters indicated in the above specification and drawings can be arbitrarily changed unless otherwise stated. For example, the various kinds of information illustrated in each of the drawings are not limited to the information illustrated in the drawings.

The components of each unit illustrated in the drawings are only for conceptually illustrating the functions thereof and are not always physically configured as illustrated in the drawings. In other words, the specific shape of a separate or integrated device is not limited to the drawings. Specifically, all or part of the device can be configured by functionally or physically separating or integrating any of the units depending on various loads or use conditions. For example, the accepting unit 134 and the sending unit 135 illustrated in FIG. 3 may also be integrated.

Furthermore, each of the embodiments described above can be appropriately used in combination as long as the processes do not conflict with each other.

In the above, embodiments of the present invention have been described; however the embodiments are described only by way of an example. In addition to the embodiment in disclosure of invention, various modifications and changes can be made in accordance with the knowledge of those skilled in the art.

Furthermore, the “components (sections, modules, units)” described above can be read as “means”, “circuits”, or the like. For example, the determination unit can be read as a determination means or a determination circuit.

According to an aspect of an embodiment, it is possible to provide an advertisement distribution management device, an advertisement distribution management method, and an advertisement distribution management program that can improve the profit obtained by distributing advertising content.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An advertisement distribution management device comprising:
an acquiring unit that acquires, for each number of advertisement requests sent to an advertisement distribution device per unit time, a profit expected value of advertising content that is distributed by the advertisement distribution device in accordance with the advertisement requests;
a determination unit that determines, on the basis of the profit expected value acquired by the acquiring unit, the number of allocations of the advertisement requests to be allocated to the advertisement distribution device; and
a sending unit that sends, on the basis of the number of allocations determined by the determination unit, a new advertisement request to the advertisement distribution device.

2. The advertisement distribution management device according to claim 1, wherein
the acquiring unit acquires, for each of the advertisement distribution devices, the profit expected value, and
the determination unit determines, on the basis of the profit expected value acquired by the acquiring unit, the number of allocations of the advertisement requests to be allocated to each of the advertisement distribution devices.

3. The advertisement distribution management device according to claim 1, wherein
the acquiring unit acquires a rejection rate that is the rate at which an advertisement request is rejected by the advertisement distribution device, and
the determination unit determines, on the basis of the rejection rate acquired by the acquiring unit, the number of allocations of the advertisement requests to be allocated to the advertisement distribution device.

4. The advertisement distribution management device according to claim 3, wherein the determination unit determines the number of allocations on the basis of the profit expected value acquired by the acquiring unit and on the basis of a profit expected value when the advertising content with respect to the advertisement request rejected by the advertisement distribution device is distributed by another advertisement distribution device other than the advertisement distribution device.

5. The advertisement distribution management device according to claim 2, wherein
the acquiring unit acquires the number of the advertisement requests for each of the advertisement distribution devices that are determined by a predetermined condition as the transmission destination of the advertisement requests accepted in the past, and
the sending unit determines, on the basis of the number of advertisement requests for each of the advertisement distribution devices acquired by the acquiring unit, on the basis of the number of allocations for each of the advertisement distribution devices determined by the determination unit, and on the basis of the transmission destination of a new advertisement request determined by the predetermined condition, an advertisement distribution device that becomes the transmission destination of the new advertisement request.

6. The advertisement distribution management device according to any one of claim 1, wherein
the acquiring unit acquires, for each price rank and for each number of advertisement requests sent to the advertisement distribution device per unit time such that the advertising content is distributed at the price rank that is set on the basis of the profit expected value obtained when the advertising content is distributed by another advertisement distribution device other than the advertisement distribution device, the profit expected value of the advertising content distributed by the advertisement distribution device in accordance with the advertisement requests, and
the determination unit determines, on the basis of the profit expected value for each price rank acquired by the acquiring unit, the number of allocations of the advertisement requests to be allocated to the advertisement distribution device for each price rank.

7. The advertisement distribution management device according to claim 6, wherein
the acquiring unit acquires a rejection rate that is the rate at which an advertisement request that requests to send the advertising content at the price rank is rejected by the advertisement distribution device, and
the determination unit determines, on the basis of the rejection rate acquired by the acquiring unit, the number of allocations of the advertisement requests to be allocated to the advertisement distribution device for each price rank.

8. The advertisement distribution management device according to claim 6, wherein the determination unit determines the number of allocations on the basis of the profit expected value acquired by the acquiring unit for each price rank and on the basis of the profit expected value obtained when the advertising content with respect to the advertisement request associated with the price rank rejected by the advertisement distribution device is distributed by the other advertisement distribution device.

9. The advertisement distribution management device according to claim 6, wherein
the acquiring unit acquires, for each price rank associated with the profit expected value obtained when the advertising content is distributed by the other advertisement distribution device in accordance with the advertisement requests accepted in the past, the number of the advertisement requests, and
the sending unit sets, on the basis of the number of advertisement requests for each price rank acquired by the acquiring unit, on the basis of the number of allocations for each price rank determined by the determination unit, and on the basis of the price rank associated with a new advertisement request, the price rank to the new advertisement request.

10. An advertisement distribution management method performed by a computer, comprising:
acquiring for each number of advertisement requests sent to an advertisement distribution device per unit time, a profit expected value of advertising content that is distributed by the advertisement distribution device in accordance with the advertisement requests;
determining on the basis of the profit expected value acquired at the acquiring, the number of allocations of the advertisement requests to be allocated to the advertisement distribution device; and
sending on the basis of the number of allocations determined at the determining, a new advertisement request to the advertisement distribution device.

11. A non-transitory computer readable storage medium having stored therein an advertisement distribution management program causing a computer to execute a process comprising:
acquiring for each number of advertisement requests sent to an advertisement distribution device per unit time, a profit expected value of advertising content that is distributed by the advertisement distribution device in accordance with the advertisement requests;
determining on the basis of the profit expected value acquired at the acquiring, the number of allocations of the advertisement requests to be allocated to the advertisement distribution device; and
sending on the basis of the number of allocations determined at the determining, a new advertisement request to the advertisement distribution device.
